(19) United States
(12) Patent Application Publication
(10) Pub. No.: US 2013/0227598 A1
(43) Pub. Date: Aug. 29, 2013

(54) Broadcast Media with Targeted Advertising

(71) Applicants: Venkatesh Srinivasan, Sunnyvale, CA (US); Ravi Subrahmanyan, Windham, NH (US); Michel Billard, Sunnyvale, CA (US); Murali Narayanaswamy, Malden, MA (US)

(72) Inventors: Venkatesh Srinivasan, Sunnyvale, CA (US); Ravi Subrahmanyan, Windham, NH (US); Michel Billard, Sunnyvale, CA (US); Murali Narayanaswamy, Malden, MA (US)

(21) Appl. No.: 13/585,551

(22) Filed: Aug. 14, 2012

Related U.S. Application Data
(63) Continuation of application No. 12/621,261, filed on Nov. 18, 2009, now abandoned.
(60) Provisional application No. 61/115,990, filed on Nov. 19, 2008.

(51) Int. Cl. H04N 21/442

(52) U.S. Cl. CPC H04N 21/44213
USPC 725/14

(57) ABSTRACT

Systems and methods are provided for renting a peripheral storage entity to a remote client. From the service provider's vantage, one method transceives negotiation signals between a remote first client (the user) and a service provider, via a network link. Using the negotiation signals, the service provider agrees to rent a peripheral storage entity to the first client, and sends digital content from the peripheral storage entity via the network link to the remote first client. The peripheral storage entity may be located with the service provider or with a remote second client. System and methods are also provided from the perspective of remote clients that are either receiving or supplying peripheral storage entity content.

### RELATED APPLICATIONS

This application is a Continuation of an application entitled, REMOTE RENTAL OF DIGITAL CONTENT PERIPHERAL STORAGE ENTITIES, invented by Venkatesh Srinivasan, Ser. No. 12/621,261, filed Nov. 18, 2009;

which claims priority to a Provisional application entitled, METHOD FOR ONLINE DVD STORAGE AND VIEWING, AND A METHOD FOR USER CONTROLLED ADVERTISEMENT DELIVERY, invented by Michel Billard and Venky Srinivasan, Ser. No. 61/115,990, filed Nov. 19, 2008. Both these applications are incorporated herein by reference.

### BACKGROUND OF THE INVENTION

1. Field of the Invention

This invention generally relates to the rental of digital content peripheral storage entities (PSEs), such as digital video disks (DVDs) and, more particularly, to a system and method for renting peripheral storage entities from a remote site and viewing their content without taking physical possession of the PSEs.

2. Description of the Related Art

Conventional DVD rental involves taking physical possession of a DVD from a video rental enterprise. Typically, the consumer must go to a store to pick up a DVD or, in the case of rent-by-mail, wait for a DVD to be picked, packed, and shipped to the consumer's home. All these instances of DVD rental require that the physical unit be physically moved to the consumers home.

Some of the limitations of this DVD rental approach center about the user taking physical possession of the DVD. The vendor must deal with customer service costs of scratches, security, and incorrectly returned DVDs. Further, DVD utilization is low—at best 1 in 3 days (assuming 1 day for rental, one to watch, and one day to return) for a store. The overhead associated with the rent-by-mail approach is typically a week.

New releases require that the vendor stock large number of DVDs, so that the average customer can rent the DVD while it is still new (typically the first 3 to 6 months). After the initial rush to watch a new release, the large number of DVD in stock become useless overhead. Finally, the physical rental approach lacks portability. For example, a consumer who is traveling does not have access to their local DVD store or rent-by-mail service.

Electronic movie rental is also possible. There are two electronic rental approaches:

1. Download and watch. This method allows the user to download the movie to their laptop or set-top. After they download the movie, they have purchased the rights to watch this movie in accordance with the purchase agreements from the vendor.

2. Streaming of movies from a server, also known as Video on Demand. This method allows the user to watch movies or shows streamed directly from the vendor's video servers.

Electronic movie rentals do not have all the features associated with a physical DVD. For example, electronic rentals do not have the extra content such as the director commentaries or additional languages. Nor do these electronic rentals have extra features such as chapter search. Further, the library of electronic rentals is typically limited. If provided by a monopoly service provider (e.g., cable company), the costs of electronic rentals can be higher than that of a physical DVD.

It would be advantageous if a user could obtain all the benefits physical DVD rental, without experiencing any of the above-mentioned pitfalls.

### SUMMARY OF THE INVENTION

Disclosed herein are systems and method that permit a user to rent, watch, and return peripheral storage entities (PSEs) loaded with digital content, without having to take physical possession of the PSEs. Digital video disks (DVDs) are one example of a PSE. In one aspect, advertisement-supported DVD rentals are enabled, which permits the user a fair degree of control on their advertisement reception experience. More explicitly, the user virtually operates a DVD player, without having to handle the physical DVD at any time. This type of DVD player is referred to herein as a virtual digital content playing console, or as a Remote DVD player in the Cloud (RDPC). DVD rentals may be combined with the RDPC to provide rapid rentals and returns, and therefore offer instant gratification for the consumer.

Specifically, the RDPC or virtual console permits the user to select a DVD from a library of DVDs they have the rights to watch. The DVD is placed automatically on a remote DVD player. The controls associated with the remote DVD player are conventional, including, but not limited to: stop, start, pause, play, fast forward, rewind, skip chapter (forward and backward), eject, menu controls, and special features like second audio channel, alternate video angle, and region control. After viewing, the DVD is returned to storage. The booklet and any special material that comes along with a physical DVD may also be viewed electronically.

Accordingly, a method is provided for renting a peripheral storage entity from a remote site. From the renting user's point of view, the method transceives negotiation signals between a first client (the user) and a remote service provider, via a network link. Using the negotiation signals, the first client agrees to rent a peripheral storage entity from a remote site. Then, the first client receives digital content from the peripheral storage entity via the network link. The digital content may be received from the service provider, a remote second client, or from both the service provider and the second client. The second client may be another service provider user or a commercial organization partnered with the service provider. The peripheral storage entity may be a DVD, high-definition (HD)-DVD, Blu-ray Disc™, compact disk (CD), or gaming media cartridge, to name a few examples.

Typically, the first client agrees to rent a peripheral storage entity having a unique identification, and the rental agreement extends the first client a set of legal rights to the peripheral storage entity. In one aspect, the first client takes virtual possession of the peripheral storage entity under the terms of the rental agreement.

From the service provider's point of view, a method is provided for renting a peripheral storage entity to a remote client. The method transceives negotiation signals between a remote first client (the user) and a service provider, via a network link. Using the negotiation signals, the service provider agrees to rent a peripheral storage entity to the first client, and sends digital content from the peripheral, storage entity via the network link to the remote first client. As noted above, the peripheral, storage entity may be located with the service provider or with a second client.

From the perspective of the second client, a method is provided for renting a peripheral storage entity to a remote first client (the user). The method transceives negotiation signals between the second client and a remote service provider, via a network link. Using the negotiation signals, either the second client or the service provider (or both) agrees to rent the use of a peripheral storage entity, and the second client sends digital content from the peripheral storage entity, destined to the remote first client, via the network.

Additional details of the above-described methods, as well as client and service provider systems for the remote rental of peripheral storage entities, are presented below.

### BRIEF DESCRIPTION OF THE DRAWINGS

FIGS. 1A through 1D are schematic block diagrams of a client device system for receiving rented content from a peripheral storage entity located at a remote location.

FIGS. 2A through 2D are schematic block diagrams depicting a service provider system for supplying content from a rented peripheral storage entity to a remotely located client.

FIGS. 3A through 3B are schematic block diagrams depicting a system for supplying rented content to a remote first client from a peripheral storage entity located at a second client.

FIG. 4 is a schematic diagram depicting some exemplary mechanics of the systems discussed above in the explanation of FIGS. 1A through 3B.

FIGS. 5 through 10 are flowcharts illustrating steps in a DVD rental process.

FIG. 11 is a flowchart illustrating an exemplary process for uniquely identifying a PSE.

FIG. 12 is a flowchart illustrating a method for selecting advertising profiles.

FIG. 13 is a schematic diagram depicting a method by which the PSE remote rental process is interrupted by advertising.

FIG. 14 is a flowchart illustrating an exemplary sequence of communication signals that take place between the SRC, SVC, and the remote DVD player, to control the display of advertisements.

FIG. 15 is a drawing depicting the marking of a serial number in a disk BCA.

FIGS. 16A and 16B are schematic block diagrams depicting a conventional media broadcast (prior art).

FIGS. 17A and 17B are schematic block diagrams depicting a system for inserting targeted advertising into broadcast media.

FIGS. 18A and 18B are schematic block diagrams of a home network (prior art).

FIG. 19 is a schematic block diagram depicting a Listener-Analyzer-Selector (L-A-S) system.

FIG. 20 is an exemplary packet (prior art)

FIG. 21 is a schematic block diagram of an L-A system performing home network routing.

FIG. 22 is a schematic block diagram of a system designed to send information to a Selector system over the home's internal network.

FIG. 23 is a schematic block diagram depicting a Selector located outside the home network.

FIG. 24 is a schematic block diagram depicting an L-A-S system as applied to home network appliances, other than a television.

FIG. 25 is a flowchart illustrating a method for renting a peripheral storage entity from a remote site.

FIG. 26 is a flowchart illustrating a method for renting a peripheral, storage entity to a remote client.

FIG. 27 is a flowchart illustrating a method for renting a peripheral storage entity to a remote client.

FIG. 28 is a schematic block diagram depicting conventional on-the-fly video transcoding (prior art).

FIG. 29 is a schematic block diagram depicting a first aspect of a transcoding accelerator.

FIG. 30 is a schematic block diagram depicting the movement of the ADV and ACV files to the file server attached logically to the cloud server CS1-FS1.

FIG. 31 is a schematic block diagram depicting a second aspect of accelerated transcoding.

FIG. 32 is a diagram illustrating an exemplary process to support Transform A.

FIG. 33 is a diagram illustrating an exemplary process to support Transform B.

FIG. 34 is a diagram illustrating an exemplary process to support Transform C.

### DETAILED DESCRIPTION

As used in this application, the terms “component,” “module,” “system,” and the like may in some instances refer to an automated computing system entity, such as hardware, firmware, a combination of hardware and software, software, software stored on a computer-readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

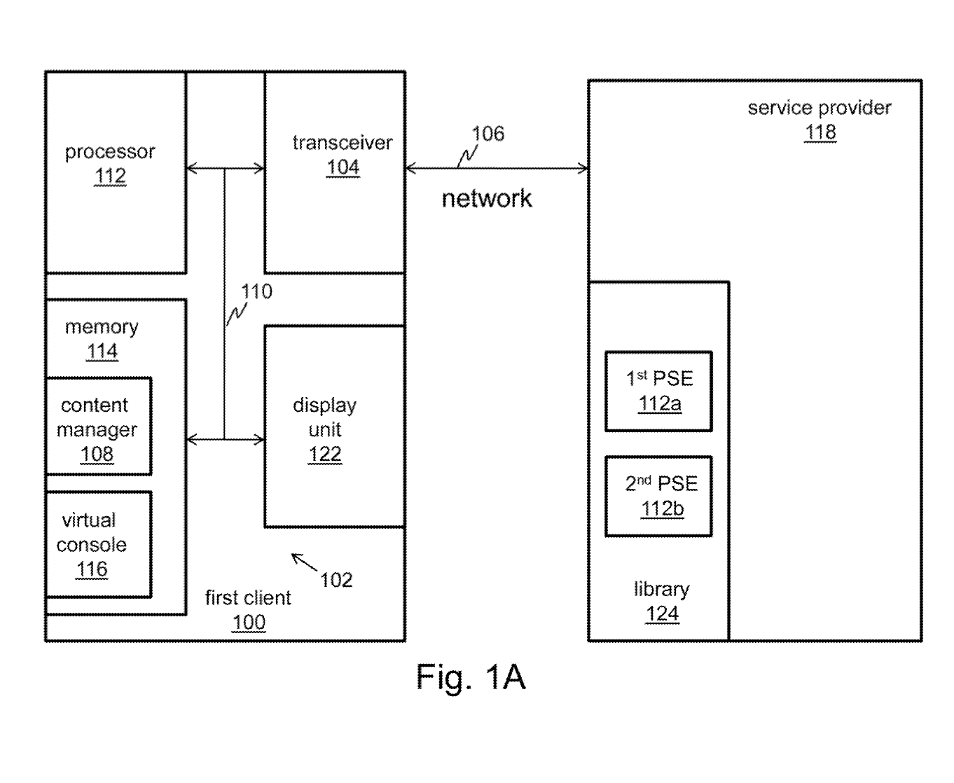

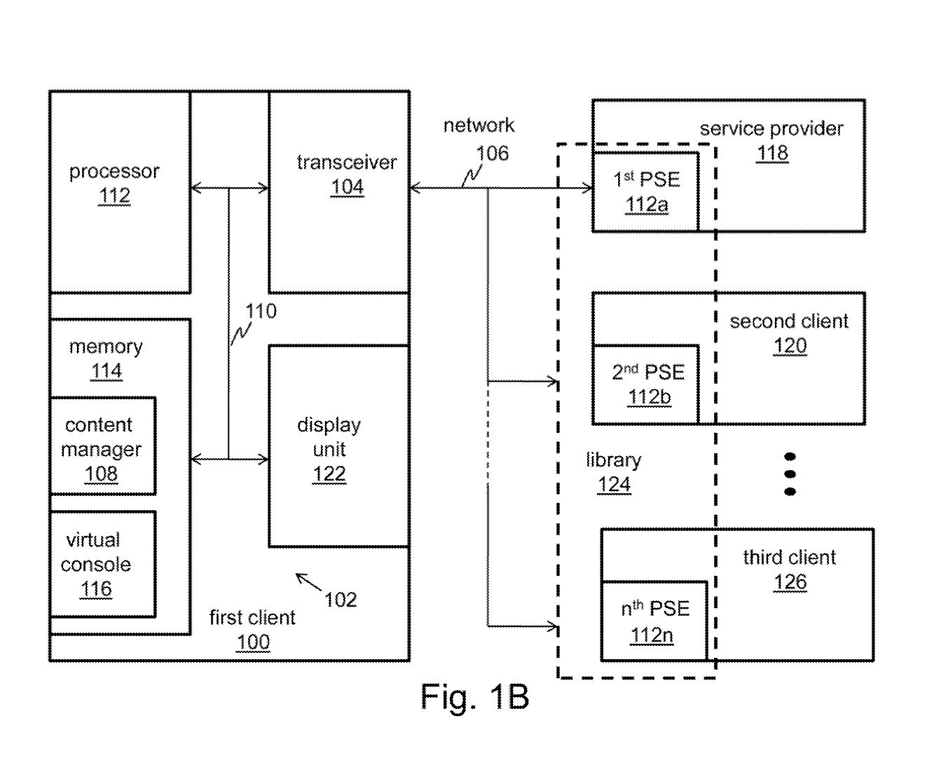

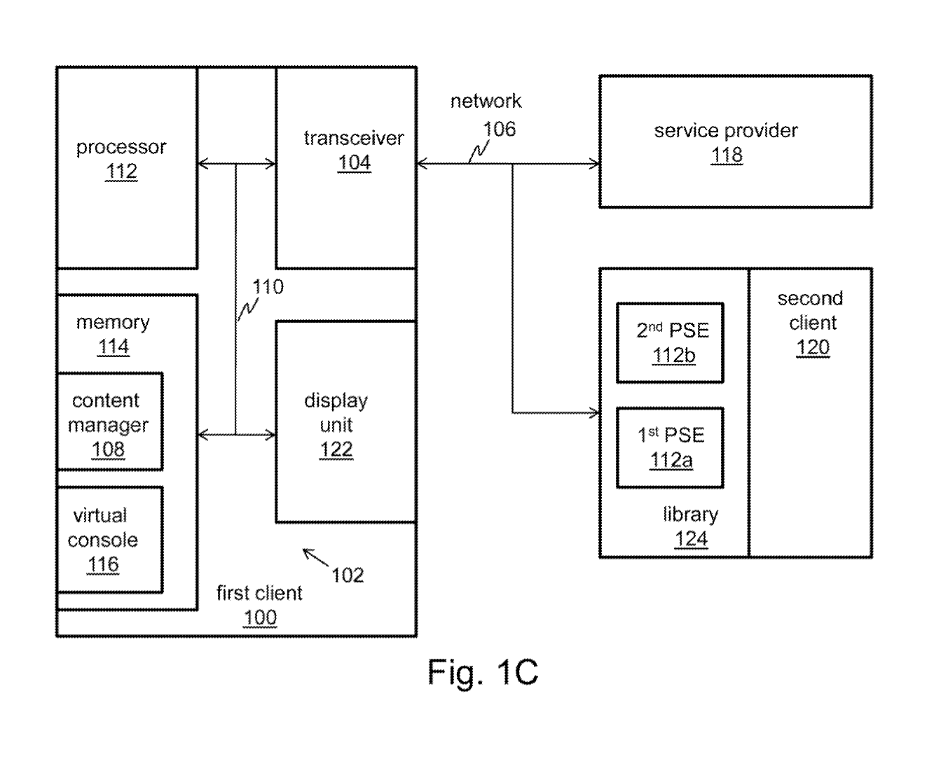

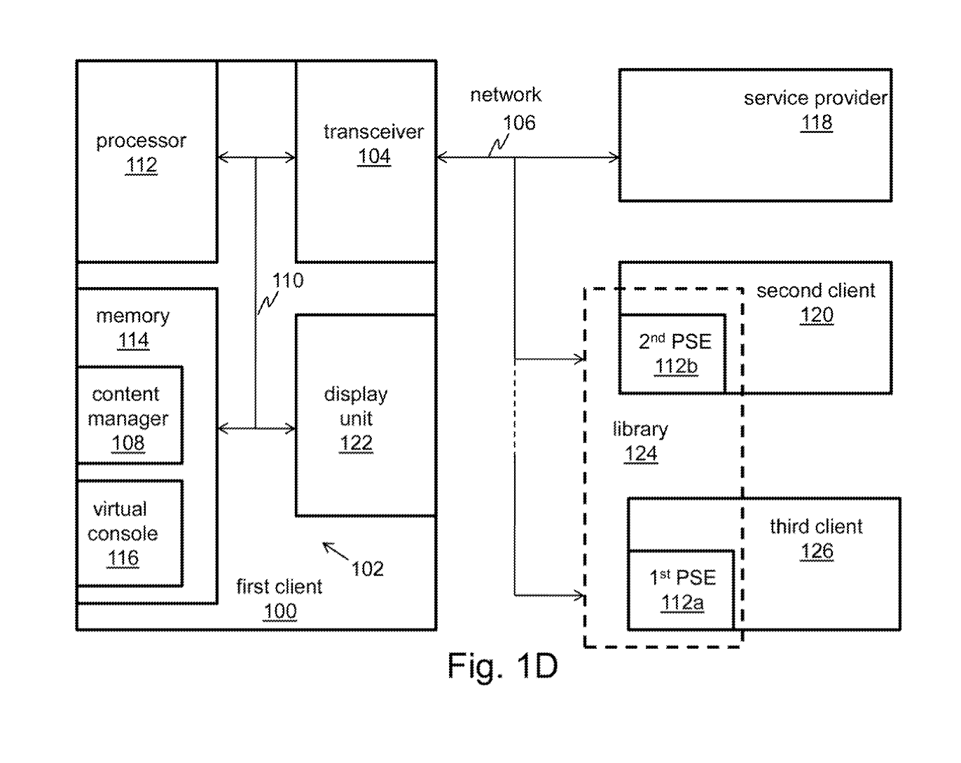

FIGS. 1A through 1D are schematic block diagrams of a client device 100 system for receiving rented content from a peripheral storage entity located at a remote location. The system 102 comprises a first client device transceiver 104 having a network interface on line 106 for transceiving negotiation signals with a remote service provider. Negotiation signals are understood to including a series of handshaking signals, or a succession of signal prompts and signal responses. The negotiation signaling may be enabled by use a proprietary software application loaded in the memory of a first client computer device, or by a modified web browser, for example. A first client device content manager 108 has an interface connected to the transceiver 104 on line 110 for originating negotiation signals selecting digital content, and creating agreements to rent a peripheral storage entity 112 located at a remote site. Movies, literature, and games are examples of digital content. A first client device virtual console 116 has an interface connected to the transceiver on line 110 for receiving the selected content from the peripheral, storage entity 112 via a network link. As explained, in more detail below, the remote site can either be a service provider or a second client. Once the digital content is processed by the virtual console, it can be displayed or performed on a display unit 122, which may includes audio speakers, a visual monitor, and gaming controls.

As used herein, the term “remote” is not defined by geographical location or network protocol. In one aspect, the network can be a local network or intranet connecting devices that are proximity located. In another aspect, the client device 100 may communicate with a modem (not shown) using an Ethernet protocol, and the transceiver 104 is a physical layer (PITY) device capable of supporting Ethernet communications. Ultimately, the client device 100 may be separated from the peripheral storage entity (PSE) 110 by thousands of miles and communicate via the Internet, in which case the negotiation signals may be digitally enveloped in successive protocol layers and carried via a synchronous optical network (SONET) network. Communicating devices are not to be considered as remote or local based upon the protocol being used to support communications.

Rather, the term “remote” defines entities that have separate identities, names, or legal standing. Thus, different modules and servers, distributed over several states, may be local components of a service provider. On the other hand, a library of PSEs physically co-located with a server of the service provider is considered to be remote from the service provider, if that library is operated by a different legal entity.

Although it would be possible to build a client network communication device exclusively from hardware, more typically the device is a computer comprising a microprocessor 112 connected via a data/address bus 110 to a memory 114. In that case, components of the first client such as the content manager 108 and virtual console 116 are enabled as applications of software instructions stored in memory 114 that are executed by the microprocessor 112. In one aspect, the client device is a set-top box and the microprocessor 112 is designed to execute only a limited number of applications. Alternately (not shown), an operating system (OS) is used to manage the above-mentioned applications, as well as other applications (not shown), such as might be embedded in a personal computer. For example, the virtual console 116 can be a modified browser application

In a simple aspect of the system, the rental agreement is established with the first client device. More typically, the rental agreement is made with a first client user such as a person, family, business, or corporate legal entity that communicates over the network via a first client device. Alternately, the first client may be considered to be a device that is known to represent a user. The rental agreement is typically supported by a user credit card or an established account that may be billed on a periodic or transactional basis. That is, the rental agreement is akin to the agreement a user makes to rent a physical DVD from DVD rental companies such as Blockbuster or Netflix, or the agreement a user makes to electronically rent a video on demand from their local cable TV provider. For simplicity, it is assumed herein that the first client (and components of the first client) is a device that is known to represent a user having a legal right to enter into a rental agreement. In one aspect, the content manager 108 accepts legal rights to the peripheral storage 112 entity under terms of the rental agreement. In another aspect, the content manager 108 or first client 100 can be said to take virtual possession of the peripheral storage entity under terms of the rental agreement.

A rental agreement typically involves the exchange of a payment for the temporary use of a good, service, or property owned by another person or company. A rental agreement may be based on an implied or expressly written contract. As such, the principles, legal rights, and legal obligations attached to a rental agreement are well understood by those with skill in the art of contract law. The renting of movies on PSEs such as DVD and Blu-ray disks is understood by some to involve the rental of non-real property. It should be understood that payment for the use of a PSE may be a promise to provide a future service, such as the use of a PSE, as well as a credit (money) transaction. While currently prohibited under in the United States under Title 17 of the United States Code, Section 109(b)(1)(A), agreements could someday also be created for the rental of music and software embedded in PSEs.

As seen from another perspective, the first client device receives transferred rights to a peripheral storage entity located at a remote site. The PSE may be a copyright-protected peripheral storage entity licensed for non-public performance, and in receiving the content, the first client device receives a non-public performance of the selected content from the peripheral storage entity.

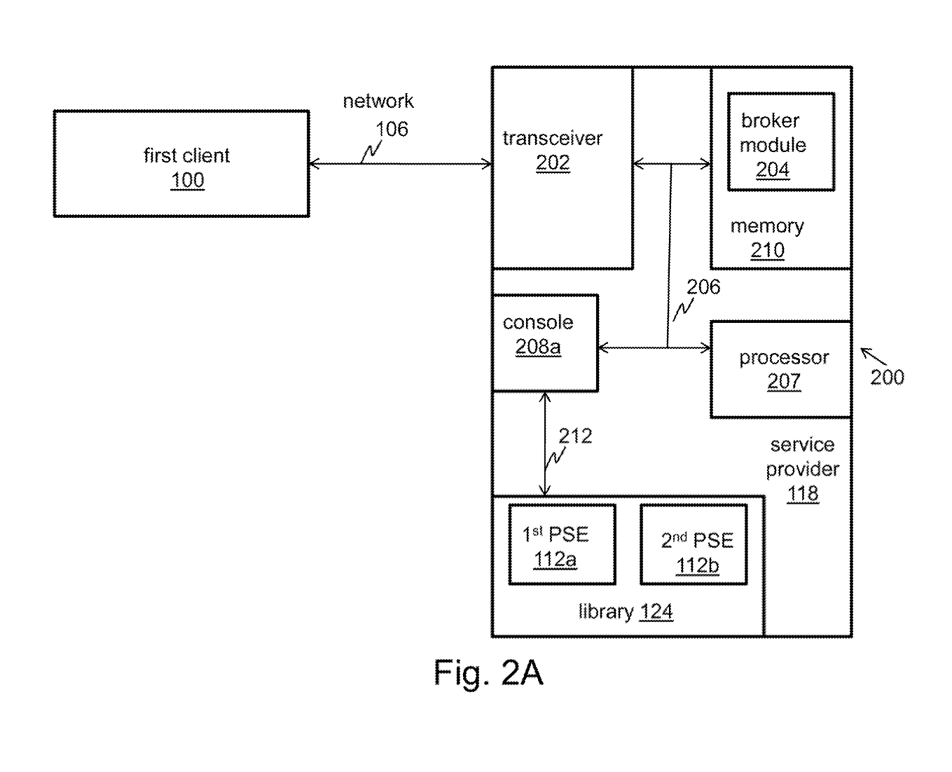

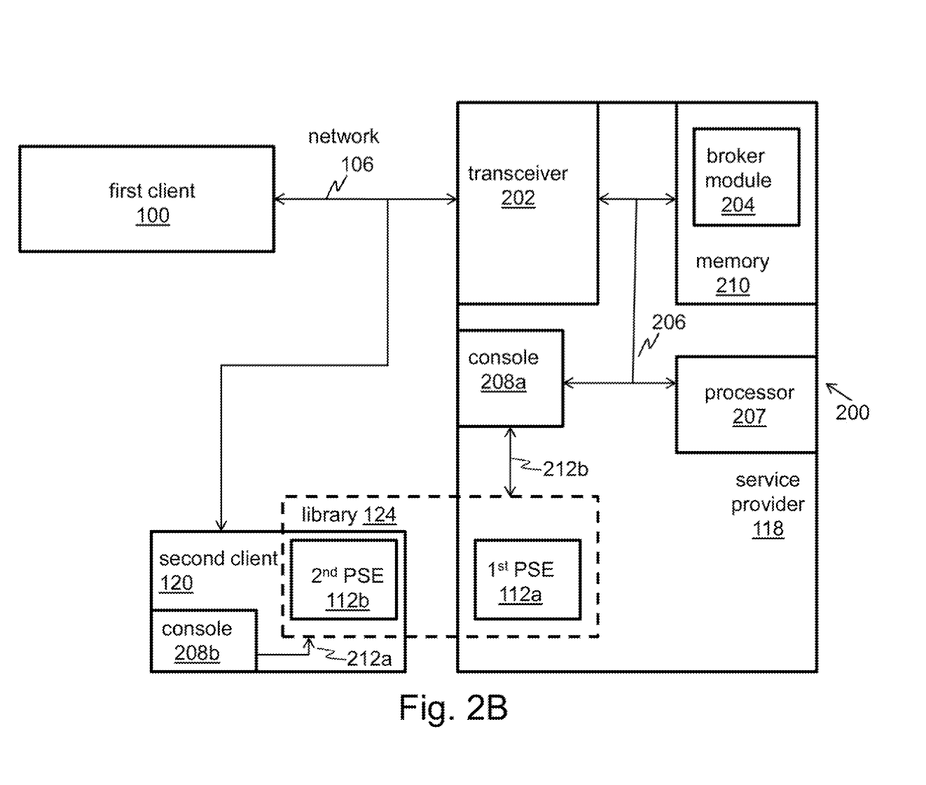

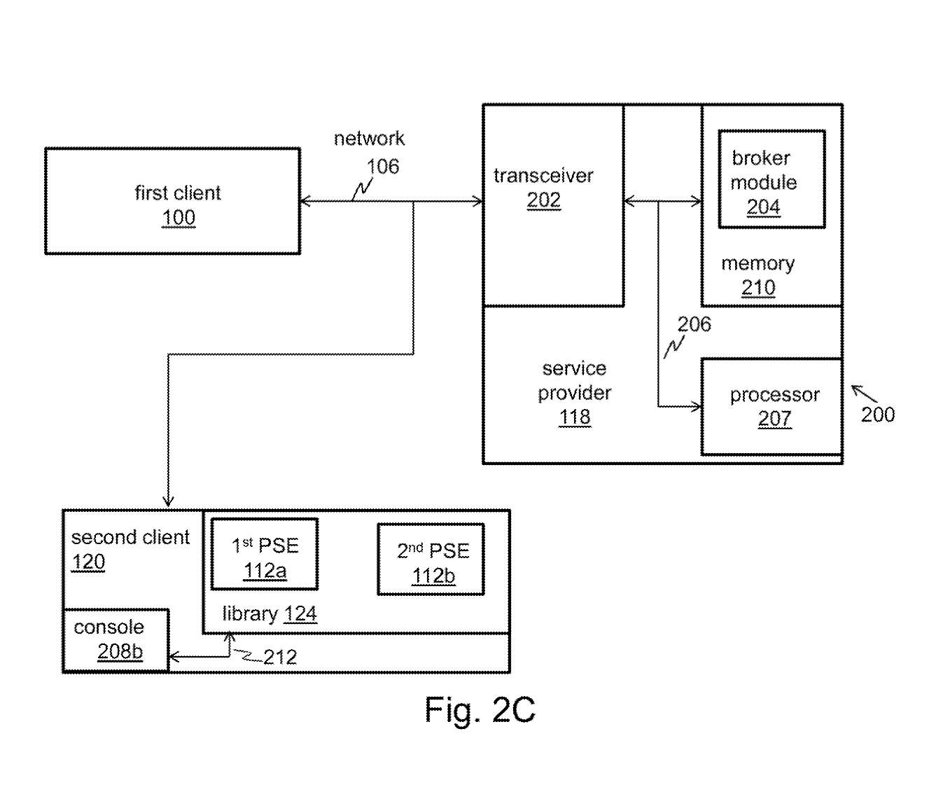

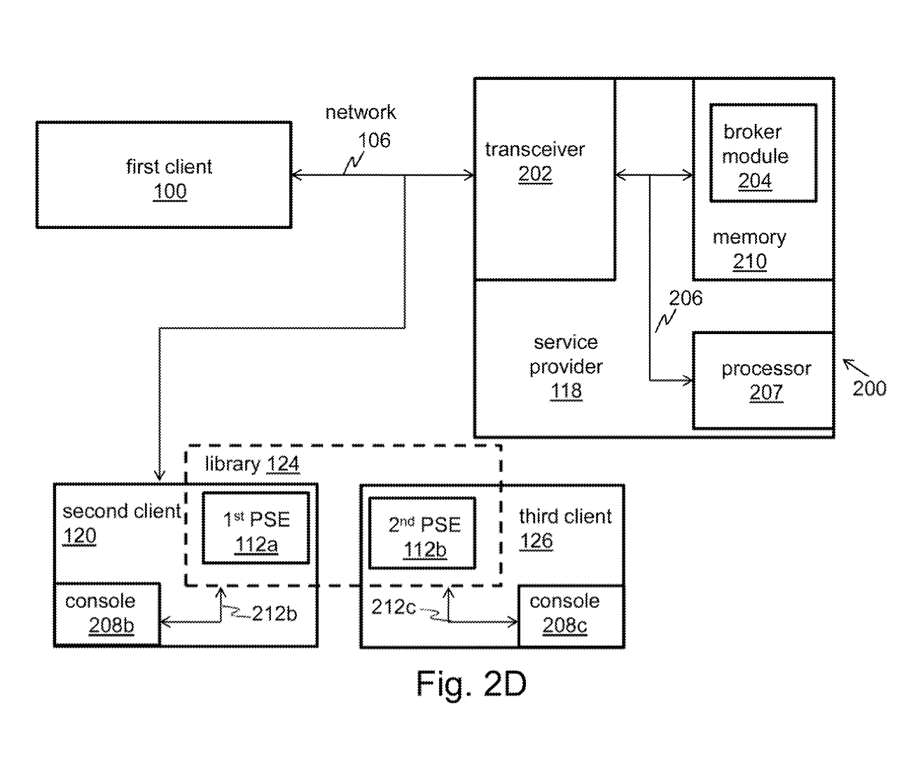

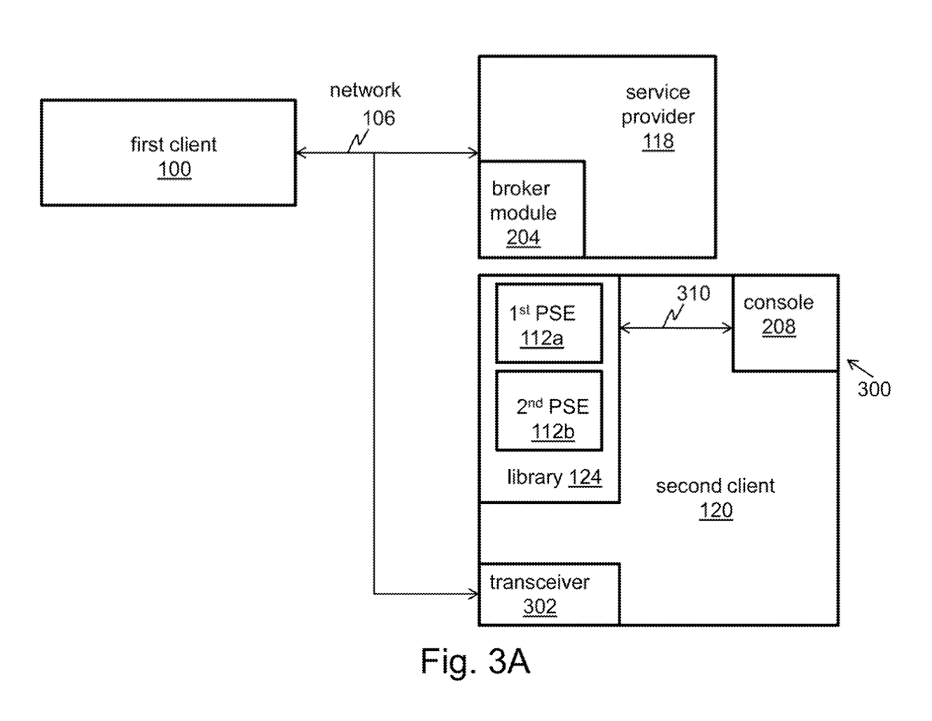

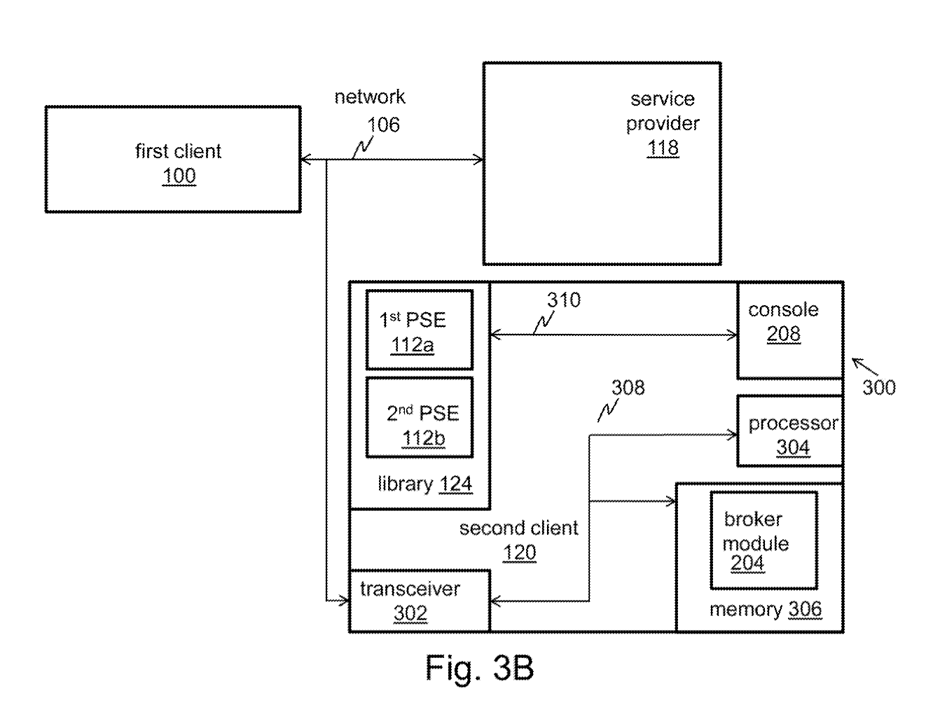

Processes performed by the system of FIGS. 1A-1D, as well as the systems described below in the explanation of FIGS. 2A-2D and 3A-3B, are not merely mental steps. In one aspect, some of the processes are enabled as software instructions that are stored in a tangible memory and executed by a processor. As such, data is retrieved from memory, manipulated, stored in memory, and communicated via electrical and/or optical waveforms. Further, a portion of the process requires the manipulation of a physical PSE and the use of a mechanical console to read the PSE.

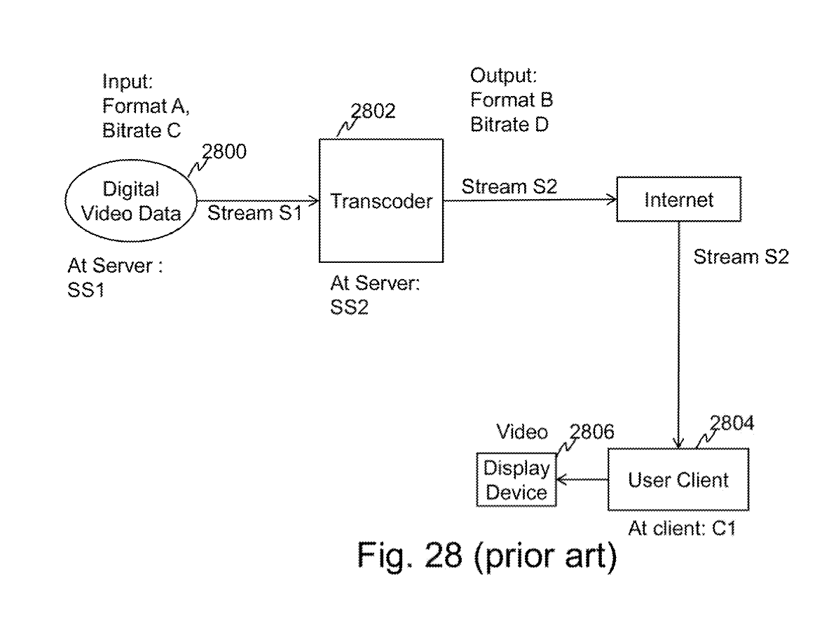

The novelty of the remote rental systems described herein is based upon a number of factors. First, there are the issues related to the remote manipulation of physical PSEs and mechanical consoles. The resolution of these issues is significantly more complicated than simply transmitting content on a hard disk, which is the technology that enables video on demand systems. Another problem solved in the instant system, which prevented other, more conventional approaches, from becoming commercially viable, is the real-time transcoding/transrating of the content from PSEs so as to fit the narrower bandwidths available to consumers. Complex video content is streamed to a user by first encoding the content for transmission (e.g., MPEG2 format). Conventionally, this encoding process is very time consuming and cannot be preformed in real-time in an inexpensive manner. Therefore, the real-time streaming of content to a home user has necessitated that the service provider make and store copies of encoded files, so that a preexisting encoded file of the requested content (e.g., movie) can be sent to a user upon demand. The instant system does not make or keep copies of content from PSEs or encoded content from the PSEs. Rather, the problem is solved by reducing the amount of data that must be encoded. Since the amount of data is reduced, it now becomes possible to supply the requested content in real-time. For example, a conventional DVD has a 6 megabit per second (mbps) output, which the systems described herein are able to take down to below 2 mbps, while still preserving very high quality. Details of the transcoding/transrating process are described in the explanation of FIGS. 28-34.

Also important is the recent legal understanding that the rule against the public performance of copyrighted movies and television shows is not violated by the transmission of such material, to a user's home (see Cartoon Network LP v. CSC Holdings, Inc., 536 F.3d 121 (2d Cir. 2008)). Without such an understanding, there has heretofore been no commercially viable reason for practitioners in the art to solve the technical issues related to the remote rental and transmission of copyrighted content on physical PSEs. Further, since the instant system is able to deliver high quality video in real-time, without making a copy of the content or encoded content, any potential issues involving the copying of copyrighted material are avoided. Thus, at least a portion of the novelty of the systems disclosed herein, is based upon an understanding of how technology can be most valuably used within the constraints of the legal system.

In one aspect, the content manager 108 may agree to rent under the terms of a single entity rental. Just as with Blockbuster or Netflix however, the user need not necessarily enter into explicit rental agreement on a PSE-by-PSE basis. Rather, the first client user may enter into an up-front agreement that supports the sequential rental of several PSEs. For example, may enter into an agreement for the rental of n-entities, n entity rentals per calendar period, unlimited entity rentals, unlimited entity rentals per calendar period, a rental with an option to purchase, or a pro-rental trial. In one aspect, the first client purchases the PSE, but stores the PSE at a remote site, and “uses” their purchased PSE remotely. This combination ownership, with remote storage and service is referred to herein as a “virtual purchase”. In another aspect, the first client can buy the PSE from either the service provider or a remote client. After using the PSE from a first remote site, the first client may choose to sell the PSE to another remote client, who chooses to keep the PSE at the first remote site. This combination of remote ownership and usage is referred to as a “rotating purchase”.

A peripheral storage entity can be a digital video disk (DVD), high-definition (HD)-DVD, Blu-ray Disc™, compact disk (CD), or a gaming media cartridge. The system is not limited to any particular type of memory medium or digital content. The term “peripheral” is used since many forms of commercial digital content are portable—they can be carried by the user and interfaced to a number of different devices. In the case of gaming cartridges, it should be understood that the first client may send, as well as receive digital content from a remote site. For example, a remote site may send audio/visual prompts to the first client, and the first client may transmit their reactions to the prompts. The remote site may also keep a history of the user's progress and preferred settings, as is common in the use of many games.

The content manager 108 agrees to rent the PSE from the service provider 118, the second client 120 (FIGS. 1B-1D), or through an agreement that involves both the service provider 118 and second client 120. The second client 120 may be another user, like the first client 100, in other circumstances. Alternately, the second client 120 is a legal entity, business entity, or person having a relationship with the service provider 118. Again, it should be understood that although the service provider and second client are being depicted as network-connected devices, that they may be legal or personal entities interacting with the first client through network-connected devices, or through devices that are known to represent legal entities.

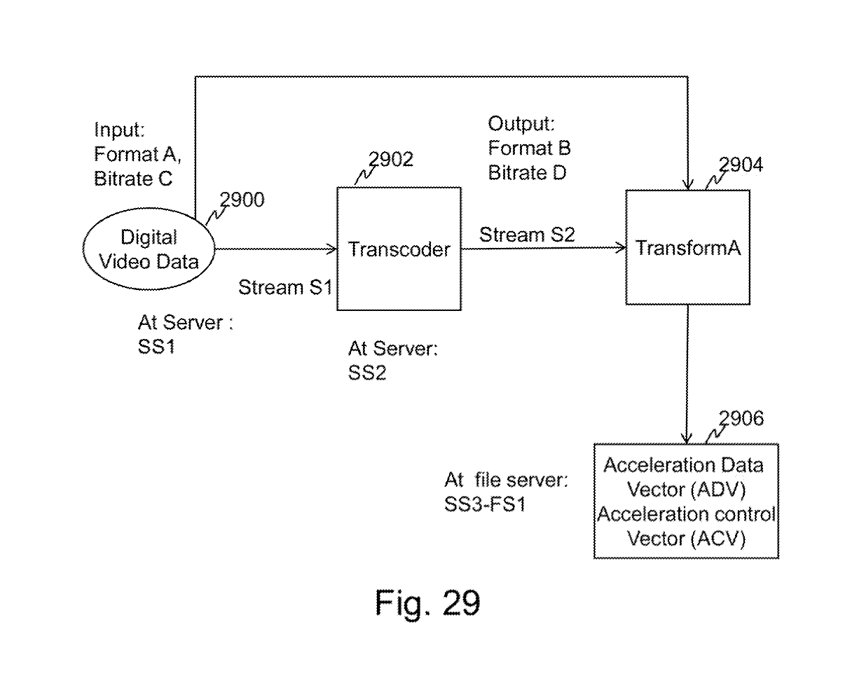

The entity renting the PSE to the first client is not necessarily the same entity housing the PSE and supplying the digital content to the user. That is, regardless of who rents the PSE 112 to the first client 100, the virtual console 116 may receive content via a network path connected to the second client 120, the service provider 118, or from both the second client and the service provider. Alternately stated, the content manager 108 may agree to rent the peripheral storage entity 112 from a library 124 distributed over a plurality of remote sites, as shown in FIGS. 1B and 1D. These remote sites may include the service provider and the second client (FIG. 1B). Further, it should be understood that the first client may be able to rent and/or receive content from a plurality of remote clients (e.g., remote clients 120 and 126, see FIG. 1D). In the simplest case, the first client may rent the PSE from the service provider 118 and receive content from the service provider, see FIG. 1A. Systems able to send content from both the service provider and the second client are described below in the explanation of FIGS. 29-34.

In one aspect, the virtual console 116 receives content from a peripheral storage entity 112 that is assigned to the first client. In that case, the peripheral storage entity is likely to have a unique identification, such as a physical marking on an exterior surface of the peripheral storage entity. If the PDE is a disk, a unique ID may be embedded in a disk burst cutting area. If not a disk, a unique ID may be embedded in the peripheral storage entity. In another aspect, the PDE is neither physical nor electronically marked, but such an unmarked peripheral storage entity may reside in a marked storage slot.

In the event that content is not received from a first peripheral storage entity 112a, the virtual console 116 may receive the content from a second peripheral storage entity 112b located at a remote site. For example, the second PSE 112b may be used if the first PSE 112a is damaged. Typically, the first and second PSEs have the same digital content, but it possible that the second PSE 112b supplies different content. For example, if there are no other available copies of the first PSE content, different content (from the second PSE 112b) may be received. In another aspect, the second PSE 112b may be used if the network link to the first PSE 112a is interrupted. Note: the first and second PSEs may be associated with different entities, as shown in. FIG. 1B. For example, the first PSE 112a may be located with the service provider 118 and the second PSE 112b may be located with the second client 120 (as shown). As another example, the first PSE may be located with the third client and the second. PSE may be located with the second client (FIG. 1D). Alternately, both the first and second PSEs may be located with the same entity (FIG. 1A or 1C).

As noted above, a particular PSE (e.g., first PSE 112a) may be assigned to the first client 100. In one aspect, the content manager's rental of the peripheral storage entity prevents another remote client (e.g., third client 126) from receiving content from the peripheral storage entity unless the first client rental has been suspended or terminated. In the event that the rental agreement, or supply of digital content is either suspended or terminated, the virtual console 116 ceases to receive content from the peripheral storage entity 112. In one aspect, the content manager 108, the service provider 118, or the entity supplying the digital content from the PSE may automatically suspend or terminate the rental of the peripheral storage entity after n hours.

In another aspect, the virtual console 116 originates negotiation signals to enter a sleep mode and the rental of the first peripheral storage entity is suspended. The virtual console 116 is able to receive content from a second peripheral storage entity in response to originating a wake mode negotiation signal. Again, it is typical that the first and second PSEs have the same content. This arrangement permits the rental of one PSE to the first client, without limiting the agreement to one particular PSE (a PSE with a particular ID). For example, content can be received from the second PSE 112b if the first peripheral storage entity 112a is currently being rented to a different client (e.g. third client 126).

FIGS. 2A through 2D are schematic block diagrams depicting a service provider system for supplying content from a rented peripheral storage entity to a remotely located client. The system 200 comprises a service provider transceiver 202 having a network interface on line 106 for transceiving negotiation signals between the service provider 118 and a remote first client 100. A peripheral storage entity 112 is shown with digital content. In FIG. 2A, a library 124 of PSEs is shown located at the service provider. In FIG. 2B, the library 124 of PSEs is distributed over the service provider 118 and second client. In FIG. 2C, the library is located at the second client 120, and in FIG. 2D, the library 124 is located at multiple clients that are remote from each other.

A service provider broker module 204 has an interface connected to the transceiver 202 on line 206 for accepting commands selecting digital content, and creating an agreement for the rental of the peripheral storage entity 112 to the first client 100. In one aspect, the broker module 204 receives a digital content selection via negotiating signals from the first client 100, locates the peripheral storage entity having the selected content in the library 124, and agrees to rent the peripheral storage entity located in the library. The broker module 204 is involved in the rental agreement, even if the library is distributed over multiple remote sites (FIGS. 2B and 2D). As shown in FIGS. 2C-2D, the library 124 is located at a second client 120, remote from the first client 100 and service provider 118, housing peripheral storage entity 112.

For example, the broker module 204 may create a rental agreement between the first client 100 and a second client 120. Then, the console 208, located at the second client, sends content from the peripheral storage entity 112 to the first client. In one aspect, the broker module is able to create a relationship between the service provider and the first client, and between the service provider and, the second client. In other words, two separate agreements. In another aspect, the broker module 204 creates a relationship between the service provider, the first client, and the second client (a three-party agreement). In a different aspect, the broker module 204 extends the first client legal rights to the peripheral storage entity under terms of the rental agreement. In one aspect, the broker module extends virtual possession of the peripheral storage entity to the first client. As seen form another perspective, the service provider 118 transfers rights to a peripheral storage entity, to the first client device. The transferred rights may be to a copyright-protected peripheral storage entity licensed for non-public performance, in that case, the service provider sends a non-public performance of the content from the peripheral storage entity.

A digital content playing (physical) console 208 supplies the selected content from the peripheral storage entity 100 to the first client via a network 106. Examples of a physical console include a conventional DVD player, game machine, or hard drive configured to supply content to a single user. Likewise, the linkage 212 between the console and PSE is a mechanical one, as the PSE is a physical device that is loaded into the mechanical console. Alternately, a PSE may be permanently assigned to a console, so that the loading operation is unnecessary. As noted above, the broker module 204 may agree to rent under terms such as a single entity rental, the rental of n-entities, n-entity rental per calendar period, unlimited entity rentals, unlimited entity rentals per calendar period, rental with an option to purchase, pre-rental trial, virtual purchase, or rotating purchase.

In one aspect, content is sent from the peripheral storage entity by the service provider console 208a, or from a client console that is remote from the service provider 118 and the first client 100 (e.g., second client console 208b, see FIGS. 2B-2D). In another aspect, content may be sent from both the client console (e.g., second client console 208b) and the service provider console 208a. In one variation, the service provider accepts a partial-content data stream from the remote console, reassembles the complete streams, and sends the complete stream to the first client. Alternately, the first client receives a first partial-content data stream from the service provider console, and a second partial data stream from the remote console.

In one aspect, the service provider is enabled in a server device incorporating at least one processor 208 and a memory 210. The broker module 204 may be enabled as an application of software instructions that are stored in memory 210 that are executed by the processor 208. The console 208 may be a conventional console, such as a DVD disk player or game machine, into which a PSE is inserted and played. The console may be embedded with the service provider 118, as shown in FIG. 2A, or with a second client 120, as shown in FIGS. 2B-2D.

In one aspect, the broker module 204 assigns a particular peripheral, storage entity to the first client. Thus, even if the console 208 is capable of reading from multiple sections (chapters) of the PSE, so that multiple clients could potential be serviced from the same PSE in parallel, the broker module 204 prevents a remote client (e.g. third client 126) from receiving content from the peripheral storage entity unless the first client rental is either suspended or terminated.

To support such a function, the PSE 112 may have a unique marking. For example, the identification may be a physical marking on an exterior surface of the peripheral storage entity, a unique ID embedded in a disk burst cutting area, a unique ID embedded in the peripheral storage entity, or an unmarked peripheral storage entity residing in a marked storage slot.

If the broker module, first client, or second client suspends or terminates the rental of the peripheral storage entity to the first client, the broker module 204 originates a signal returning the peripheral storage entity to the library 124. In one aspect, the broker module 204 automatically suspends or terminates the rental of the peripheral storage entity to the first client after n hours.

In the event of a failure to send content from a first peripheral storage 112a entity to the first client, the console 208 sends content from a second peripheral storage entity 112b. Depending upon the distribution of the library 124, the second PSE 112b may, or may not be located at a site that is remote from the first PSE 112a. The broker module may suspend the rental of the first peripheral storage entity 112a to the first client, in response to sleep mode negotiation signals from the first client. In that case, the console 208 may send content to the first client from the second peripheral storage entity 112b, in response to broker module receiving a wake mode negotiation signal. In one aspect, the console sends content from the second peripheral, storage entity to the first client, if the first peripheral storage entity is currently being rented to another client.

FIGS. 3A through 3B are schematic block diagrams depicting a system for supplying rented content to a remote first client from a peripheral storage entity located at a second client. The system 300 comprises a second client transceiver 302 for transceiving negotiation signals with a remote site via a network link 106. The remote site may either be the first client 100 or the service provider 118, acting as an agent or intermediary for the first client. In this system, the peripheral storage entity 112 with digital content is local to the second client 120. A broker module 204 accepts a command selecting digital content, and creates an agreement to rent a peripheral storage entity to the first client device. There are several types of rental agreements possible, as described above in the explanation of systems 100 and 200.

The broker module may be located at the service provider, as shown in FIG. 3A, or at the second client, as shown in FIG. 3B. The broker module 204 can be enabled as a software application of processor 304 executable instructions stored in memory 306, connected to the processor via a bus 308.

A second client digital content playing console 208 supplies the selected content, destined for the first client 100, from the peripheral storage entity 112 via the network 106. The console sends content from the peripheral storage entity via a network path either directly to the first client 100 or to the service provider 118. If not already loaded in the console 208, a PSE 112 may be moved by a physical means from the library 124 to the console, as represented by reference designator 310.

In system 300 the library 124 housing the peripheral storage entity 112 is local to the second client. The broker module 204 of FIG. 3A or 3B receives a digital content selection from the first client 100 via negotiating signals, locates the peripheral storage entity 112 having the selected content in the library 124, and agrees to rent the peripheral storage entity in the library.

In one aspect, the broker module 204 agrees to rent under terms of a relationship between the service provider 118, the first client 100, and the second client 120 (a three-way agreement). Alternately, the broker module may agree to rent the peripheral storage entity to the service provider (a two-way agreement between the second client and the service provider). Note: in the later case there may exist a separate agreement between the service provider and the first client. In another aspect, the broker module 204 extends legal rights, or virtual possession of the PSE to the first client under terms of the rental agreement.

As seen from another perspective, the second client 120 transfers rights to a peripheral storage entity, to the first client device. The transferred rights may be to a copyright-protected peripheral storage entity licensed for non-public performance. In that case, the second client sends a non-public performance of the content from the peripheral storage entity.

As noted above, the PSE 112 may have a unique identification, such as a physical marking on an exterior surface of the peripheral storage entity, a unique ID embedded in a disk burst cutting area, a unique ID embedded in the peripheral, storage entity, or an unmarked peripheral storage entity residing in a marked storage slot. This identification helps make possible the sending of content from a particular peripheral storage entity assigned to the first client. Further, the broker module 204 may prevent a remote third client (not shown) from receiving content from the peripheral storage entity 112 unless the rental agreement is suspended or terminated, in one aspect, the console 208 sends content from the second peripheral storage entity 112b, in the event of a failure to send content from the first peripheral storage entity 112a. Alternately, the broker module may simply suspend or terminate the rental agreement in the event of a failure to send content from the peripheral, storage entity. For example, a second PSE may not be available.

If the broker module 204 suspends or terminates the rental of the peripheral storage entity 112, it originates signals directing the peripheral storage entity 112 to be returned to the library 124. In another aspect, the broker module automatically suspends or terminates the rental of the peripheral storage entity after n hours.

In one aspect, the console 208 enters a sleep mode in response to negotiation signals and suspends the rental of a first peripheral storage entity, PSE 112a. The console may resume sending content from the first PSE 112a, or send content from the second peripheral storage entity 112h, in response to receiving a wake mode negotiation signal. For example, content from the second PSE 112b may be sent if the first peripheral storage entity is currently being used under terms of a different rental agreement.

### Functional Description

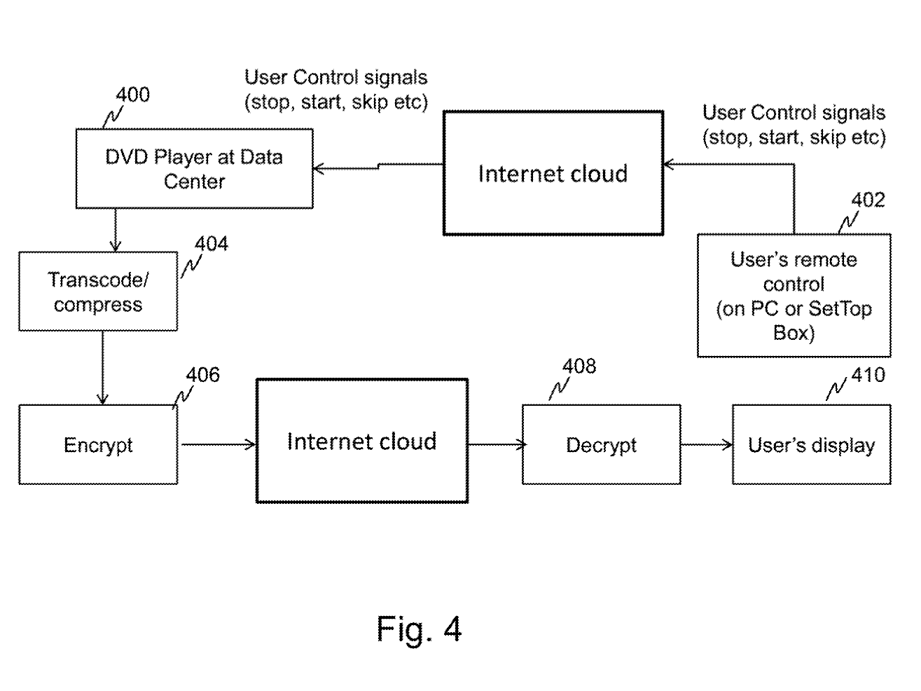

FIG. 4 is a schematic diagram depicting some exemplary mechanics of the systems discussed above in the explanation of FIGS. 1A through 3B. In this example, the PSE is a DVD. The DVD player 400 (console) is embedded in a data center located remotely from the user, and has a physical DVD loaded onto it. The user is provided with a Software Viewing Client (SVC) on their PC or via a set-top box (STB) 402 and Software Remote Control (SRC). Control signals from this SRC are transmitted to the data center and passed on to the DVD player in the cloud. The DVD player, in turn, responds to these control signals and at all times is under the control of the user.

When the user clicks “play”, the video output stream from the DVD player is compressed 404 and coded 406 in a format suitable for transport securely across the Internet. Once the signals reach the SVC on the user's PC or STB, these signals are first decrypted 408, and then uncompressed to a format suitable for view 410 by the user's client. It can be noted that any video delivery requires that a physical DVD be located in the drive and spinning in order for the viewer to receive any video (content) from a DVD.

Thus, the system permits a user to rent DVDs from the provider of the service (service provider). This provider has a library of DVDs co-located with the RDPC. When a user rents a DVD, it is should be noted that they are renting an actual physical DVD, and when the user is renting this DVD, no other user shall be able to rent, view, or otherwise access that particular instance of the DVD for the duration of the rental.

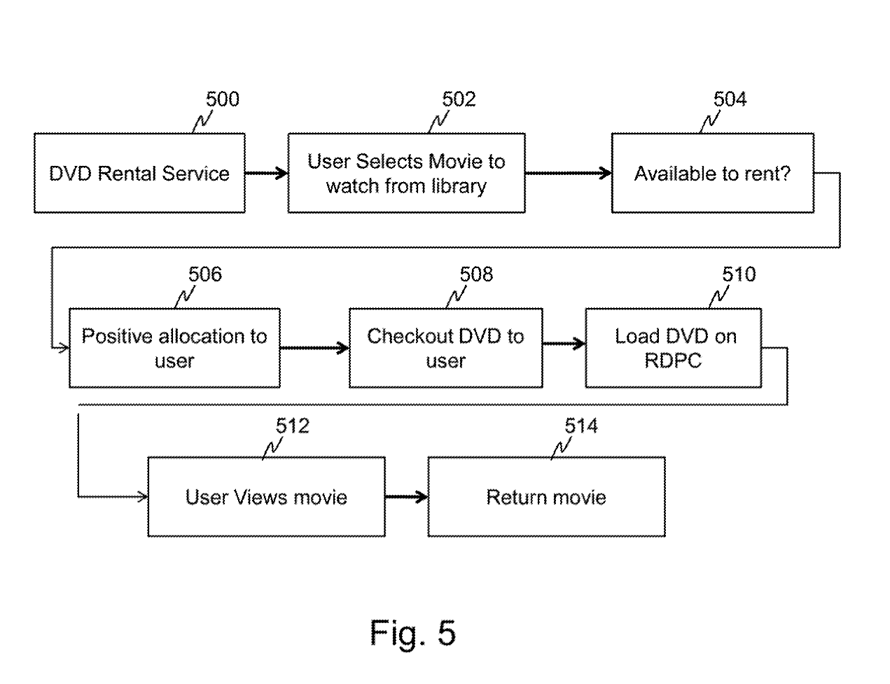

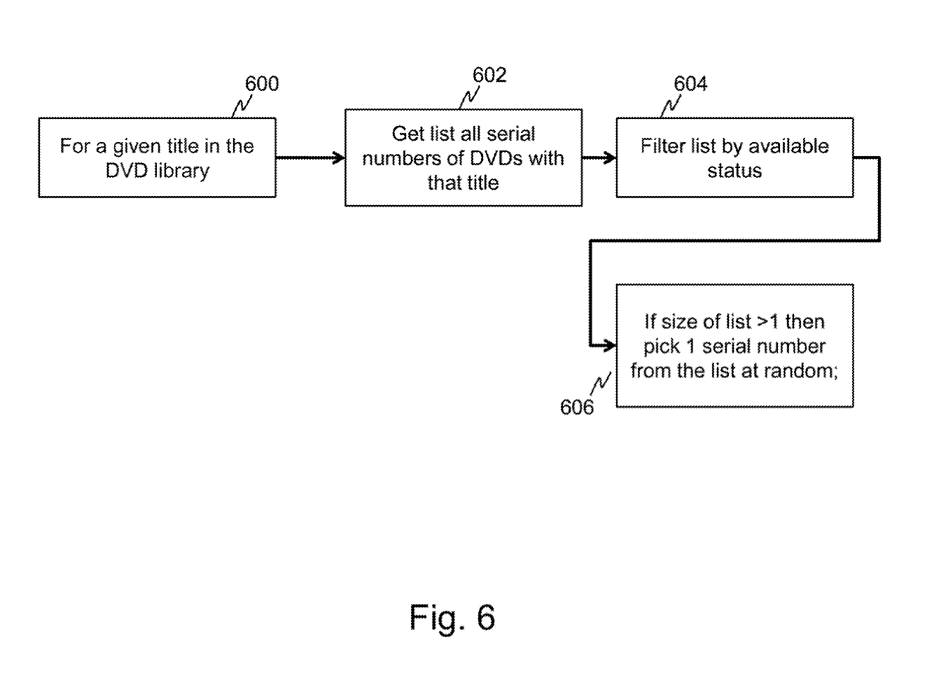

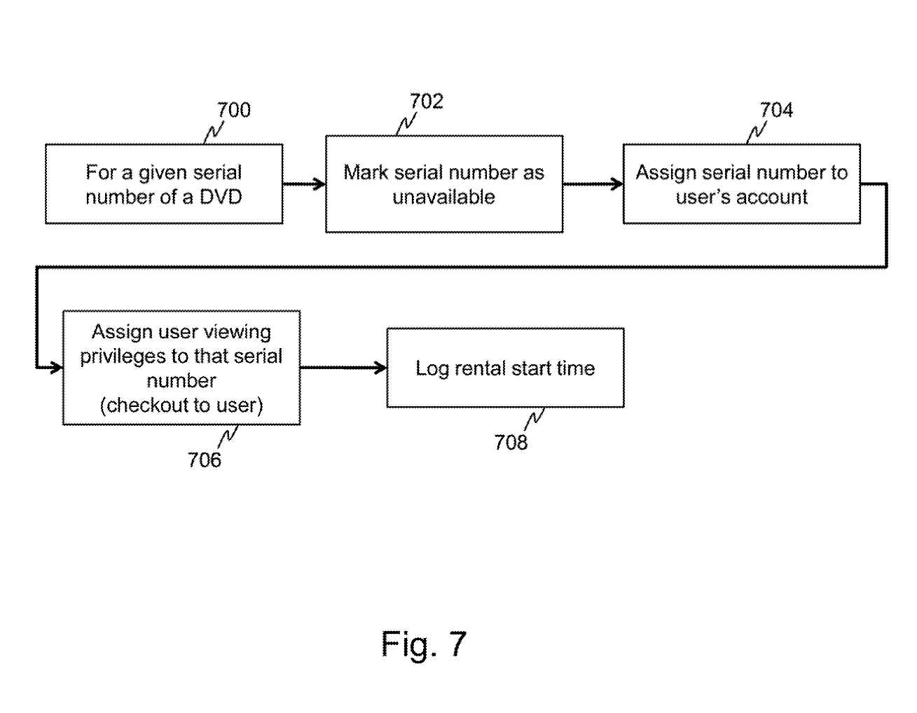

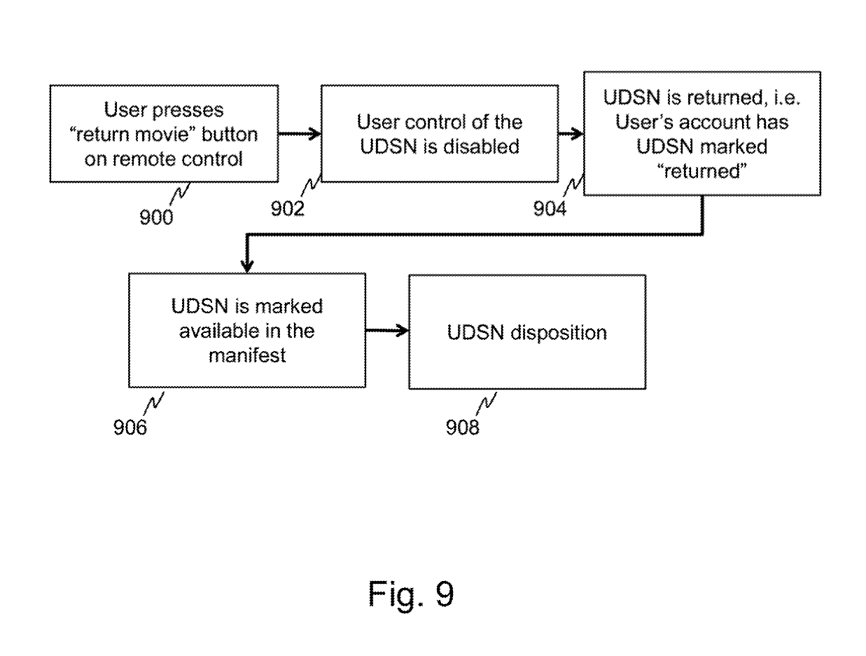

FIGS. 5 through 10 are flowcharts illustrating steps in a DVD rental process. In Step 502 the user selects a particular DVD Title (also referred to herein as a “Movie”) from the library of movies available to rent. Typically, there is more than one instance of that DVD title in the library. Each instance has a unique serial number permanently marking the DVD (see DVD handling and escrow, below). In Step 504 the system then checks the Global System Manifest (GSM) to see if any instance of the title selected by the user is available for rent. Details of this process are depicted in Steps 600 through 606 of FIG. 6. If a title is available, then one such DVD with a unique disk serial number (UDSN) is picked for rent to the user, and if not available, the viewer may be offered another title or another time slot (also see FIG. 9). The next step (Step 506) locks the UDSN to the user a process that is referred to herein as “positive allocation”. Substeps of this process are depicted in Steps 700 through 708 of FIG. 7. The purpose of this step is to assign a UDSN to the user, and simultaneously make it unavailable to anyone else by marking the particular serial number unavailable in the GSM.

Once the UDSN is positively allocated to the user, the DVD is checked out (rented) to the user (Step 508), as described in FIG. 7 with greater detail. This step involves making an entry in the user's DVD rental log (DRL) that contains the UDSN, and the date and time of the rental. At this point legal rights to view the DVD are transferred to the user in accordance with the terms of the rental agreement between the user and the entity operating the rental service and RDPC and appropriate rental fees accrue to the user's account. During the period of the rental, the entity operating the service no longer has control of the DVD—but rather acts as an escrow agent on behalf of the user. Actions performed on the DVD originate from the user, either directly or based on instructions issued by the user. Various additional service fees such as storage, late fees, etc., may also accrue to the user's account.

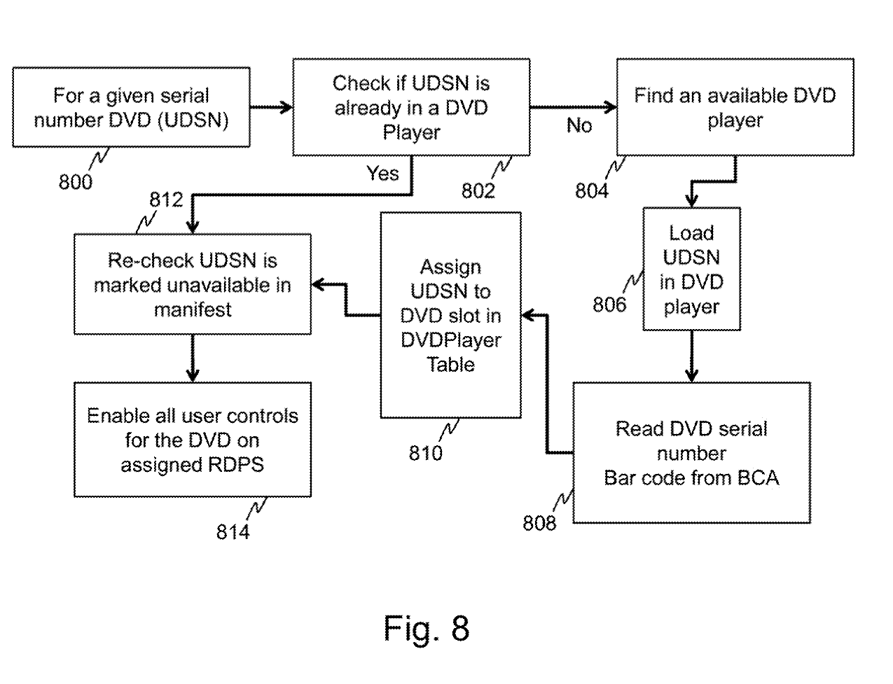

In Step 510 the UDSN is automatically loaded onto an available DVD player as described with greater detail in Steps 800 through 814 of FIG. 8. In one aspect, this player is then positively allocated to the user for the duration of the rental. Positive allocation means the entire DVD player along with the UDSN that has been rented by the user shall not be accessible by anyone other than the user. Alternately, the DVD player and UDSN may become available to other users if the rental to the initial user is suspended. In order to ensure this, the serial number of the allocated DVD player is entered into the user's DVD Player Rental Log (DPRL) and the Global DVD Player Rental Log (GDPRL). Only after these steps are complete does the user get assigned control of the DVD player via his software client.

In Step 512 the user is assigned control, and watches the DVD as they would any DVD on a regular (local) DVD player, except that the user and the DVD/DVD player are in different (remote) locations. When the user is done watching (Step 514), they click a button that says “return DVD rental”.

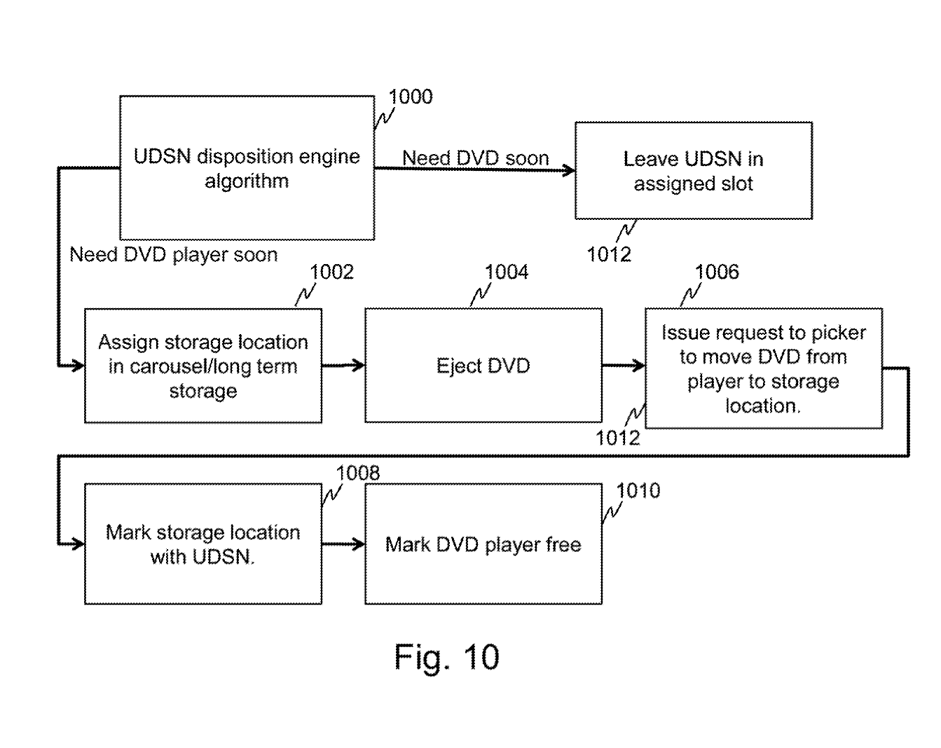

This workflow of Step 514 is depicted with greater detail in Steps 900 through 908 of FIG. 9. In Step 902, the user's control of the UDSN and the RDPC player are disabled. In Step 904, the UDSN is marked “returned” in the user's DVD rental log and available in the GSM (Step 906). Any final fees associated with the rental may be collected and/or charged to the user's account at that time. The DVD player assigned to the user is marked “returned” in the DPRL and as “free” in the GDPRL. Finally, in Step 908 a DVD disposition service is called to determine whether the DVD should be left in the DVD player or removed and moved back to storage. This process is depicted with greater detail in Steps 1000 through 1012 of FIG. 10.

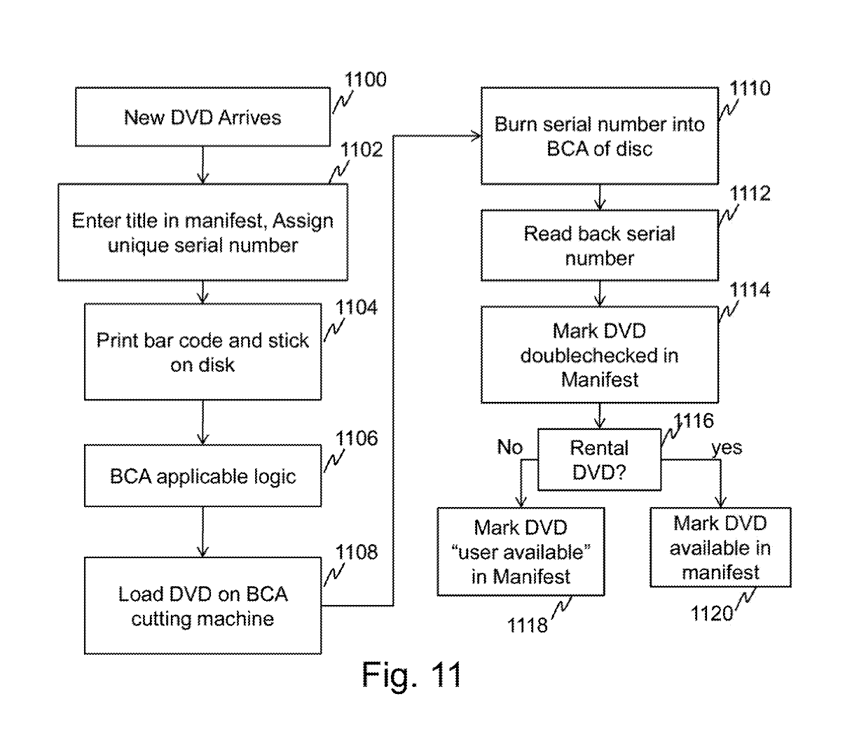

FIG. 11 is a flowchart illustrating an exemplary process for uniquely identifying a PSE. Again, a DVD is used as an example of a PSE. However, it should be understood that the process may also apply to other forms of content and storage medium. Each DVD received by the service is assigned a unique DVD serial number. No DVD in the library shares its unique serial number with any other DVD in the library. When a DVD first enters the system the following procedure is followed.

Step 1100 checks to determine if the DVD already has a serial number in the Burst Cutting Area (BCA) of the DVD. If it does, then a check is made to determine if that serial number has been assigned to any other disk in the GSM. If the serial number has already been assigned, a new number is assigned to the disk, and a process is invoked to make this serial number on the BCA unreadable any further (for example, by over-writing with permanent ink, or pasting a permanently fixed label over the BCA).

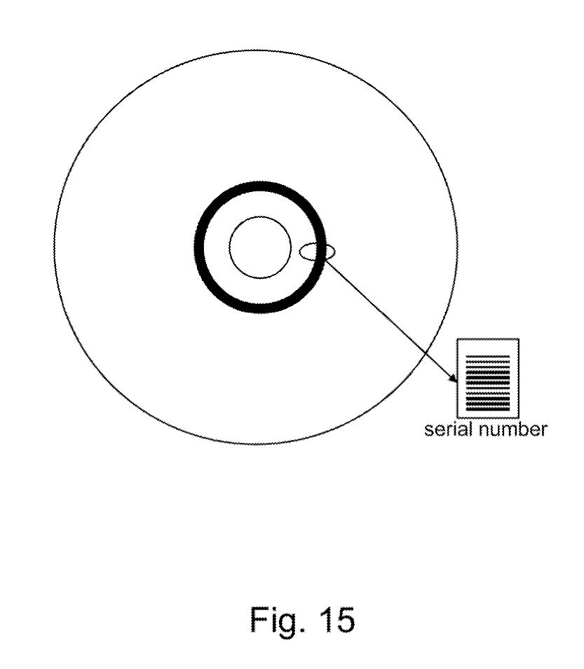

Step 1102 enters the title and serial number in the GSM. Step 1104 prints a bar code or RFID tag or other unique numbering method that represents the serial number on the DVD. This marking is different than, and, in addition to the bar code in the BCA, for use by DVD handling systems before the DVD is placed on the DVD player. Step 1106 is associated with BCA applicable logic. If the DVD is owned by the service and the serial number doesn't already exist in the BCA, then the serial number is printed into the BCA, Steps 1108-1110 (see FIG. 15).

In Step 1112, the serial number is read back from the BCA (if applicable) and from the bar code affixed on the DVD, and the DVD is marked as “double-checked” on the GSM (Step 1114). The disposition of the DVD is decided in Step 1116. If a particular user owns the DVD, then Step 1118 marks the status of the DVD as “user available”, along with the user name in the GSM. Otherwise, Step 1120 marks the DVD as “available”, which means that any user can rent this DVD as long as it has a status of “available”.

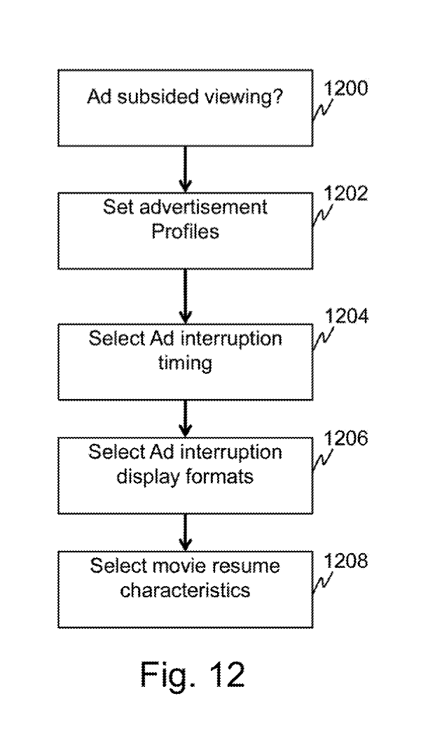

FIG. 12 is a flowchart illustrating a method for selecting advertising profiles. The PSE (e.g., DVD) remote viewing service can be supported in two ways—paid for by user, or subsidized by advertising, in one aspect, the user is permitted to select whether they want their viewing experience interrupted by advertisements (also referred to herein as “ads”) in exchange for free or subsidized viewing. If the user chooses to have their viewing interrupted by advertisements (Step 1200), then the user is permitted to customize their advertisement interruption experience (Step 1202).

Step 1204 selects advertisement interruption timing. The user is permitted to select from a series of options that allow the user to select the length of the advertisement break, and the number of ads in each break. They may also choose a combination of these for different ad breaks during the movie. The user may design their own advertisement interruption timing profile, such as choosing interruptions at the nearest scene break from a database of scene breaks for that particular movie.

Step 1206 selects the advertisement display format. The user is allowed to select from a series of options. These options may include the size of the border around the advertisement where the “paused” DVD frame from the movie being watched may be seen, or whether the border fades to black, to name a couple of examples. Step 1208 selects Movie resume characteristics. The user is allowed to select from a series of options that include whether the movie resumes from exactly the position at which it was paused, is rewound or fastforwarded by a fixed time, or rewound or fastforwarded to the “next scene”.

The advertisement may also require a click through with the remote or the mouse, so that the user does not miss any part of the movie if the movie starts automatically. This may be an option selectable by the user. The user may also elect to set what advertisement categories of interest, so that these advertisements are preferentially shown, if available. The entire collection of settings selected by the user is referred to as the user's advertisement profile or UAP.

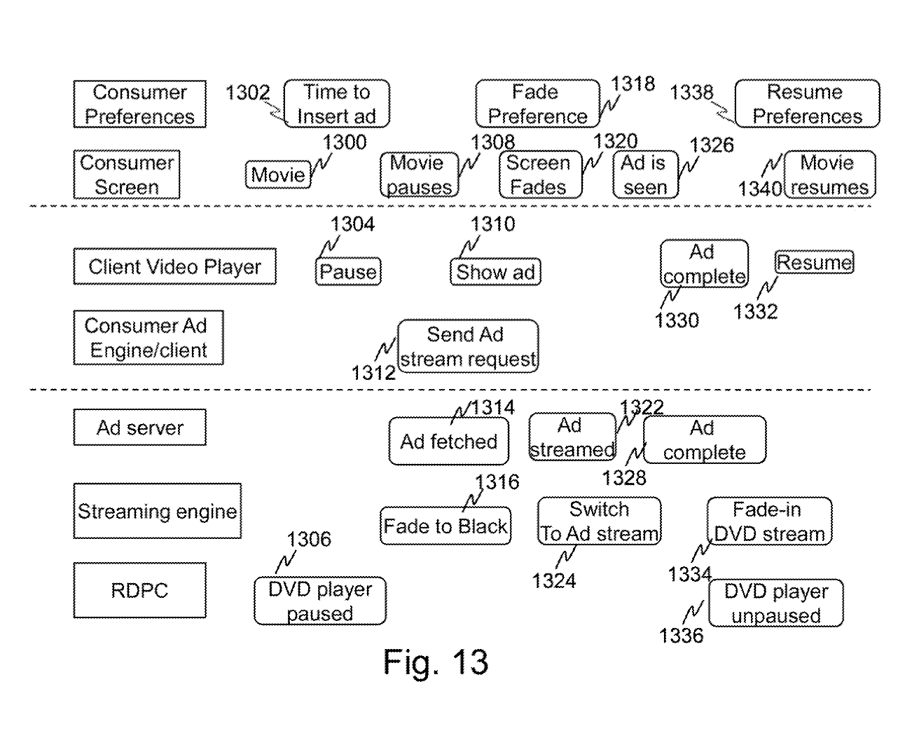

FIG. 13 is a schematic diagram depicting a method by which the PSE remote rental process is interrupted by advertising. In the spirit of the user's complete control of the movie experience, the user initiates all advertisement requests directly, or automatically from the client's computer, based upon the user's advertisement profile selected by the user. Before the movie starts (Step 1300), the client computer reads the UAP. Based on the UAP, the user's software client waits for the time to insert an advertisement. When that time arrives (Step 1302), the user's SVC warns the user, and the SRC sends a pause signal to the remote DVD player (Step 1304-1306).

In Steps 1308-1338, the user's SVC inserts a picture in picture (PIP) overlay on top of the paused frame. The size of the frame and the disposition of the original picture are controlled by settings requested by the user. The user's SVC then requests the server to stream an advertisement (or series of advertisements), which are shown in the PIP frame. These ads may also have been streamed earlier and cached on the user's computer or STB.

When the advertisements are complete, the user clicks “resume movie” (Step 1340). When the user clicks resume movie, the PIP frame is closed, the original paused movie frame is returned (or unfaded from black depending on the UAP settings). The user's SRC then sends a “play” signal to the DVD player to resume play.

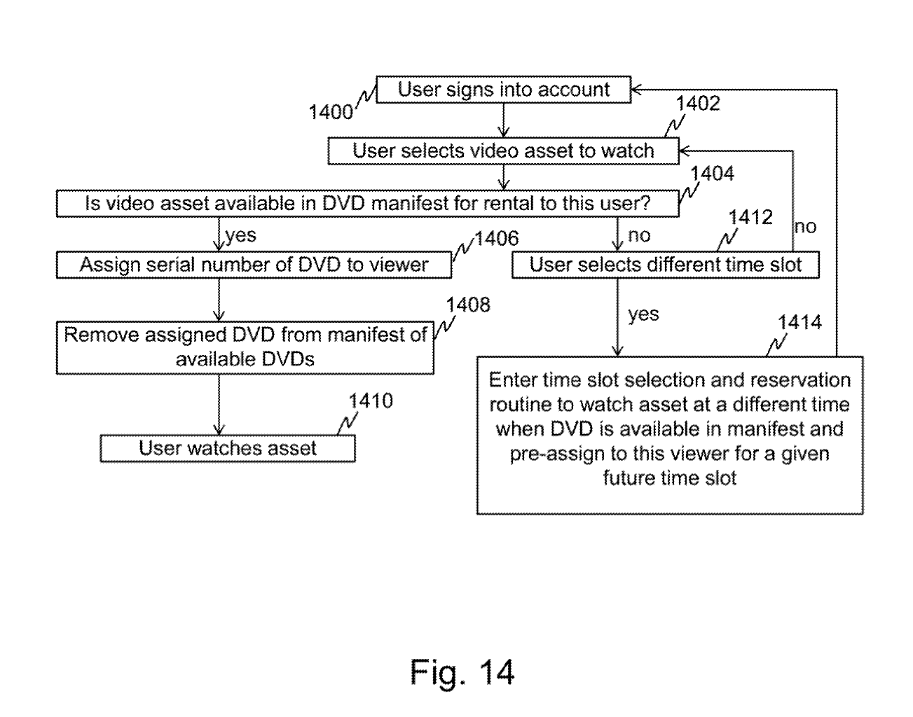

FIG. 14 is a flowchart illustrating an exemplary sequence of communication signals that take place between the SRC, SVC, and the remote DVD player, to control the display of advertisements. In Step 1400 a user signs into their account. In Step 1402, the user selects a PSE. Step 1404 determines if the PSE is available. If available, Step 1406 assigns a particular PSE to the user, Step 1408 removes that PSE from the list of available PSEs, and Step 1410 supplies content from the PSE to the user. If the PSE is not available, Step 1412 permits the user to select a different time slot, and Step 1414 reserves the time for an available PSE. If the user does not select a different time slot, they can select a different PSE (with different content), returning to Step 1402.

FIG. 15 is a drawing depicting the marking of a serial number in a disk BCA.

### GLOSSARY OF TERMS

BCA (Burst Cutting Area)—This is a special area on the inside of the disc where special codes are written. This area is not typically accessed by a conventional DVD player.

DPRL—DVD Player Rental Log—keeps track of the serial number of the DVD players assigned to the user.

DRL—Users DVD rental log. Each user has a rental log that keeps track of the serial numbers assigned to them.

GDPRL—Global DVD Player Rental Log—keeps track of the serial numbers of all the DVD players in the service (service provider) and to which users they have been assigned.

GSM—Global System Manifest—A table of every single physical DVD in the library with its corresponding title, serial number, and availability status.

Paused Frame—This refers to the frame of the movie when the user's SRC sent a signal to the DVD player requesting that playback be paused.

PIP (Picture in picture)—This refers to a mechanism by which a second video stream is superimposed on top of an existing video stream. Typically, the PIP does not cover the entire screen.

RDPC Remote DVD—Player in the Cloud.

RFID—Radio Frequency Identification—these are small tags with embedded computer chips that contain a unique serial numbers.

SRC—Software Remote Client—the software that runs on the users computer or STB that allows the user to send control signals to the remote DVD player.

STB—Set-Top Box

SVC—Software viewing Client—the software that runs on the users computer or STB that allows the user to view video content being sent remotely from the RDPC.

library—This is the list of unique titles of DVDs available to the user for rental and subsequent viewing.

service or service provider—this refers to the entity operating the RDPC system, advertisement system and DVD rental service.

UAP—User's Advertisement Profile.

UDSN—Unique Disk Serial Number. Depending on the context, the UDSN may refer either to the DVD with the unique serial number or the serial number itself.

The remote rental systems described herein offer a vendor unique supply chain efficiencies, by eliminating the need to mail or handle physical DVDs. Instead, the vendor offers the user the entire DVD experience remotely. These systems permit a user greater mobility, while having control over the entire DVD rental process. It allows the user unique choices in terms of immediacy of rental and viewing that heretofore has not been possible with the DVD format. Further, a unique method of advertising permits the user greater control over the advertisement experience. Finally, a set of checks and balances ensures that the DVD is rented to only one person at a time, and that it is controlled only by that user

Also disclosed herein are systems and method for identifying user interests based on IP traffic analysis inside the home for the purpose of determining which media advertisement is to be shown to the user.

Conventional broadcast media, such as broadcast TV and radio, use advertisements that are sent from the station to all subscribers. These advertisements are therefore designed and chosen to have broad appeal, because the medium does not permit them to be targeted to individual customers. New technology, including but not limited to, packet-based television, known in some embodiments as Internet Protocol Television (IPTV) leads to the possibility of targeting advertisements very selectively, including down to the individual subscriber level. While the technology to slot in advertisements at an individual subscriber level is preexisting, it is not a simple matter to decide which advertisement should be shown to the user, i.e. what the user's interest is likely to be.

Disclosed herein is a noninvasive approach with strong elements of user privacy, to identify user interests in a timely manner, which can then be used to selectively target advertisements based on very precise criteria applicable to the subscriber. This information can be used to serve advertisements to the user on any number of devices in the household, including but not limited to TV, radio, computer, gaming systems, and the telephone. This approach has a number of advantages over the prior art, most notably that of comprehensiveness, user privacy, timeliness, and quality.

Many companies track user behavior today. There are broadly 3 categories of user tracking:

a) Use of publicly available information, name, address, neighborhood demographics, household income etc that is used for a variety of direct marketing campaigns. This information, in and of itself, is not very useful for the purpose of targeting advertisements at an individual household level.

b) Websites track user behavior on their sites. For example, Amazon.com is well aware of all of a user's searches and purchases, and has built fairly sophisticated and, detailed models about users' behavior on its web site. This is true for most every well-run commercial web-site. This information is closely held by the operator of the web-site and unlikely to be shared with, say, the advertising agency for a car company, it is therefore, unlikely for these user profiles/information to get translated into targeted advertisements on other media like television.

c) Large scale operators of Internet media like Yahoo, NewsCorp, Google, etc., have the ability to track the user as they go to multiple sites, even properties they don't own, because they have contracts to serve web-based ads for those properties. Through the use of cookies and tracking of the user on their own properties, these companies can build fairly sophisticated profiles of the individual user. Despite extensive networks, they still have the limitation that they have only knowledge of a user's internet habits for the properties they own/serve.

An issued patent entitled, “Techniques for intelligent video ad insertion”, by Zigmond et al. (U.S. Pat. No. 6,698,020), describes a mechanism for inserting ads into the video stream delivered to the TV using a household home entertainment system (HHES). An HHES is defined as a display and computing device. Criteria used to serve the ads include demographic data supplied by the viewer, TV viewing habits as controlled and measured by the HHES, and browsing/purchases made by the user on the HHES.

In contrast to Zigmond, the approach disclosed herein analyzes all packet traffic in the household, not just on any one computer or computing device, to put together patterns of user behavior that may then be used by any other “ad inserter” to serve relevant ads to the customer. Using information about a user's browsing habits on a single computer to display targeted advertisements (banner and video) on the same computer has been accepted industry practice since 1995 and is routinely done by practically every website in the world. For an example of other related prior art, see U.S. Pat. No. 5,948,061, assigned to DoubleClick, with an issue date of Sep. 7, 1999 (filed Oct. 29, 1996). Furthermore, in practice few people actually browse on television, so the practical usability of Zigmond's method of determining user behavior and interests to meaningfully serve up an advertisement is so small as to be practically meaningless.

Other important differences—the approach disclosed herein elicits user information contained in other kinds of digital traffic in the household—e.g. Video, Voice over IP traffic, gaming traffic, etc., and envisions serving customized ads across all of these media, not just television.

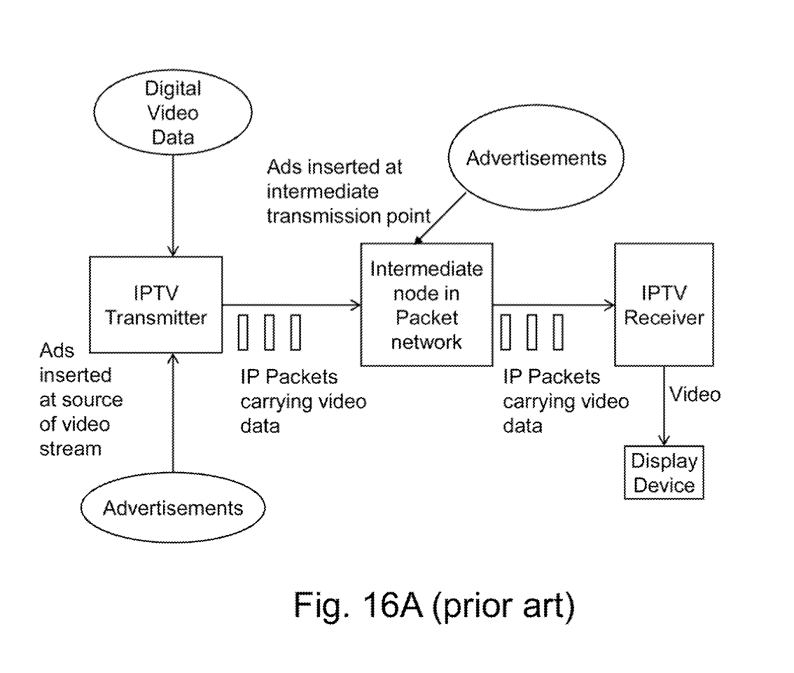

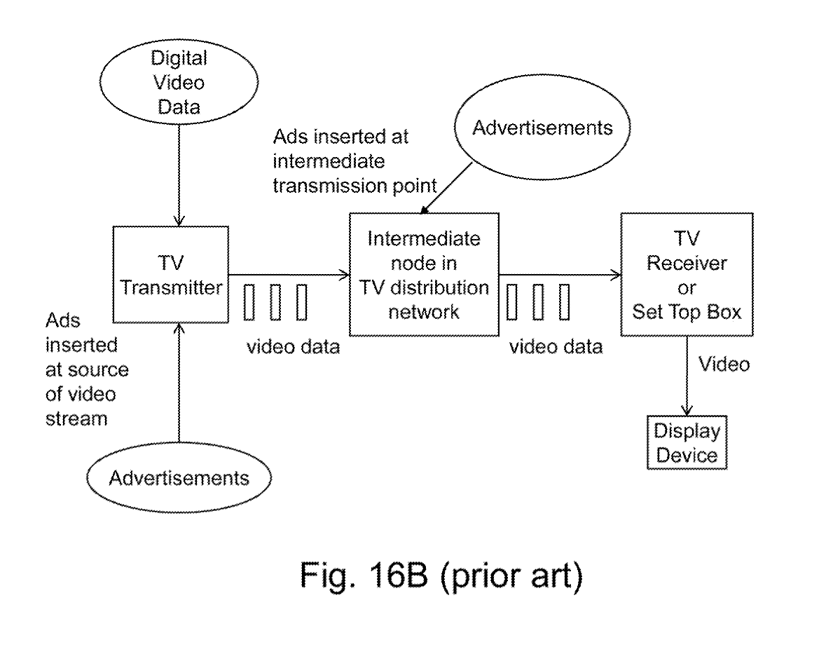

FIGS. 16A and 16B are schematic block diagrams depicting a conventional media broadcast (prior art). Conventional broadcast media, such as broadcast TV and radio, use advertisements that are sent from the station to all subscribers. These advertisements are therefore designed and chosen to have broad appeal, because the medium does not permit them to be targeted to individual customers.

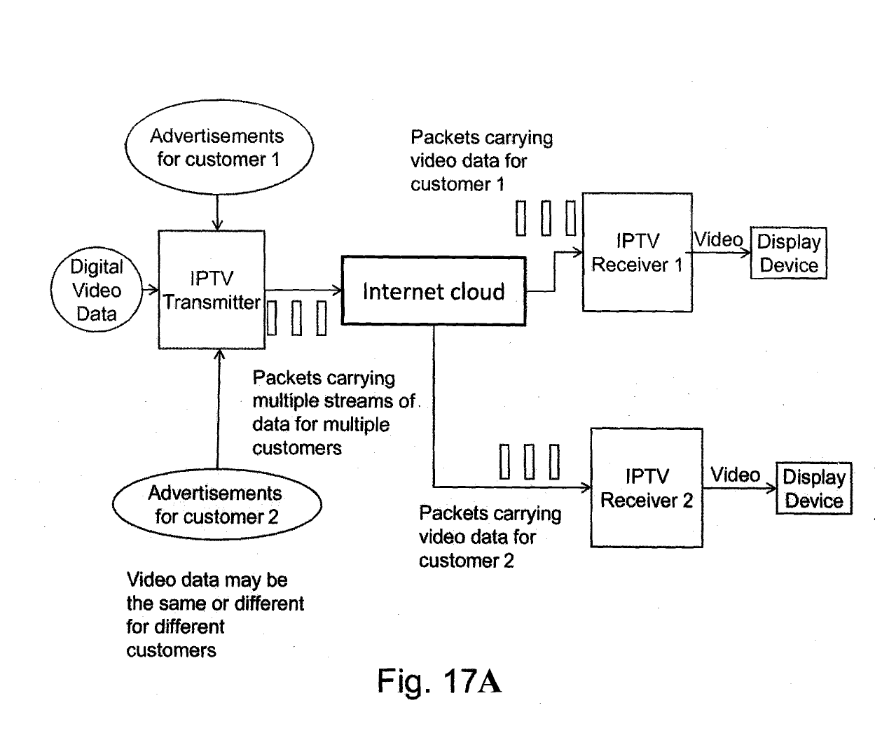

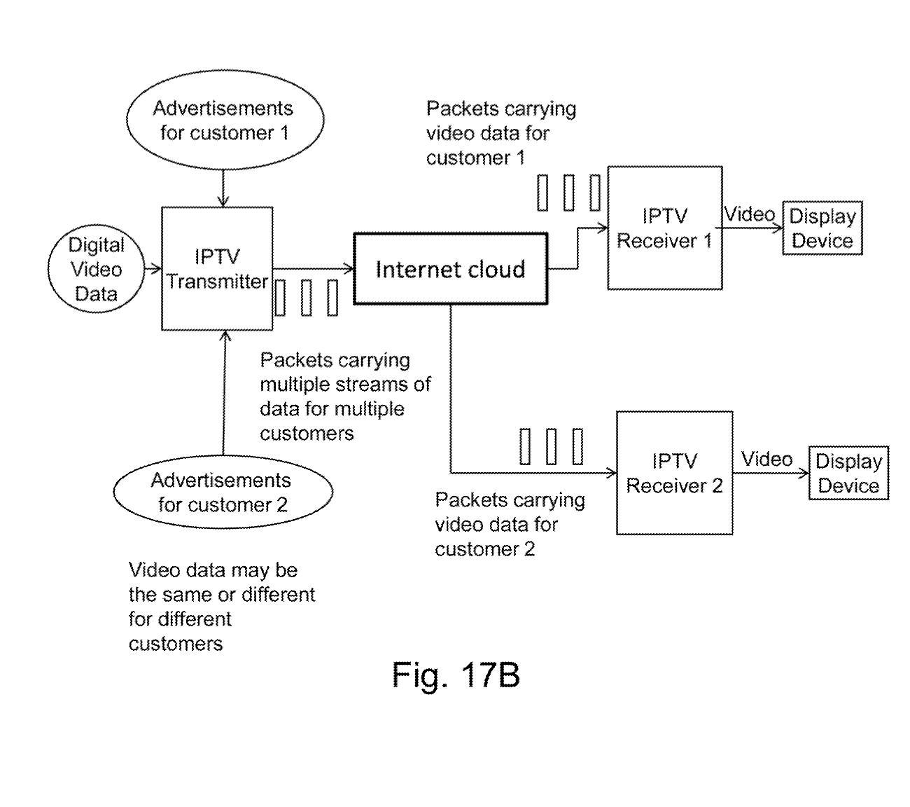

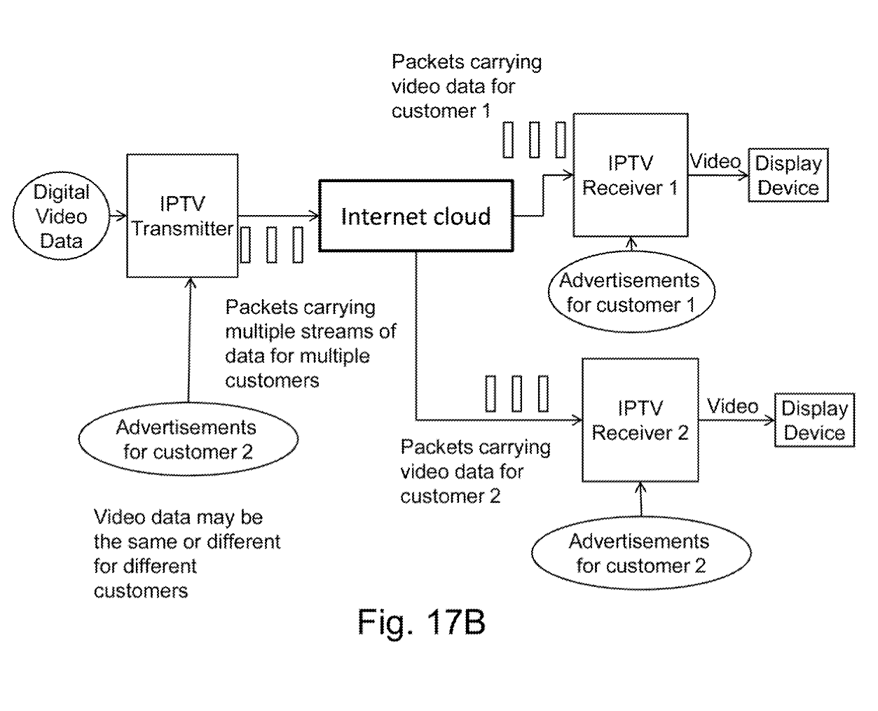

FIGS. 17A and 17B are schematic block diagrams depicting a system for inserting targeted advertising into broadcast media. Recent technology, including but not limited to IPTV, now makes it possible to send advertisements targeted at the individual user, i.e. it is possible for 2 neighbors to get 2 completely different advertisements even if they are watching exactly the same TV program.

However this powerful ability creates the problem of deciding which advertisements to send to a particular customer. In conventional broadcast media, advertisements are targeted broadly since advertisements cannot be targeted to individual subscribers, and the advertisements are therefore less effective, since a viewer may see many advertisements in which he or she has no interest. It appears likely that by serving advertisements more carefully, more advertisements of interest to a particular customer may be served, increasing the overall effectiveness of the advertisements, as well allowing sellers to better compete for a particular customer's business.

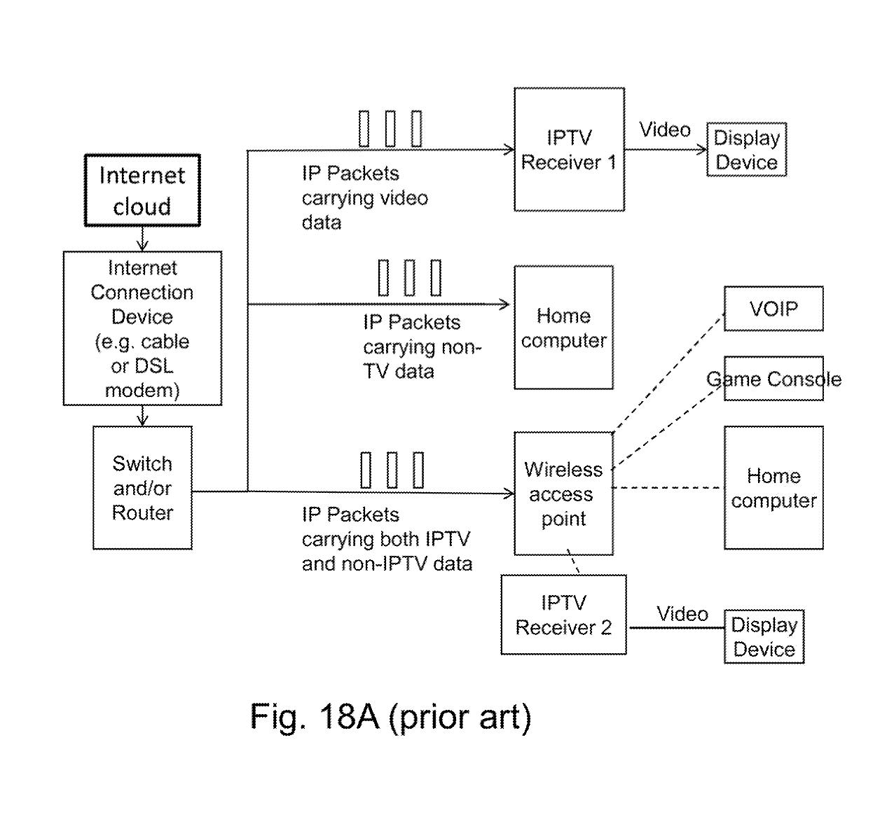

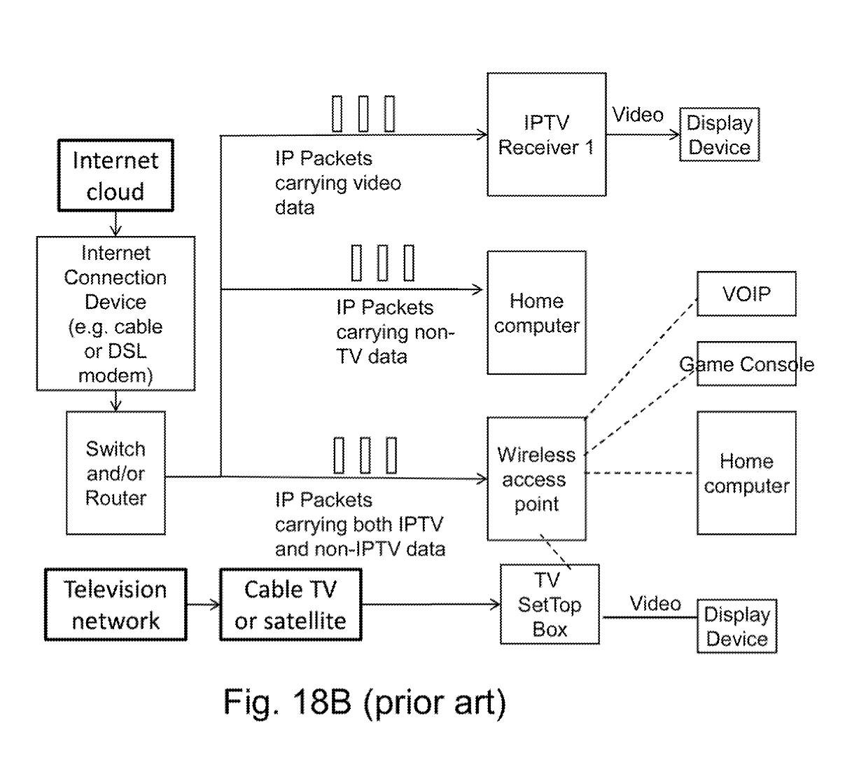

FIGS. 18A and 18B are schematic block diagrams of a home network (prior art). Low cost and high speed broadband, and high speed wireless technologies have brought about a rapid adoption of these technologies in the US and around the world. The typical home network has one Internet link, over broadband. This link usually goes into a router or a router/wireless accesspoint combination unit. From there, the broadband access is shared over a LAN/WLAN inside the home by multiple devices in the home. Examples of devices that use the LAN/WLAN include computers, laptops, gaming systems, cellular phones, Voice over IP (VOIP) telephones, music players, video players, photo displays, etc.

Most televisions setups these days have some kind of set top box (STB) to decode programming and provided advanced features of the cable or satellite network. These STBs are often digital in nature, and often have (or can easily have) the ability to communicate with an external packet based network. Some newer TVs have the ability to plug into the users home LAN/WLAN.

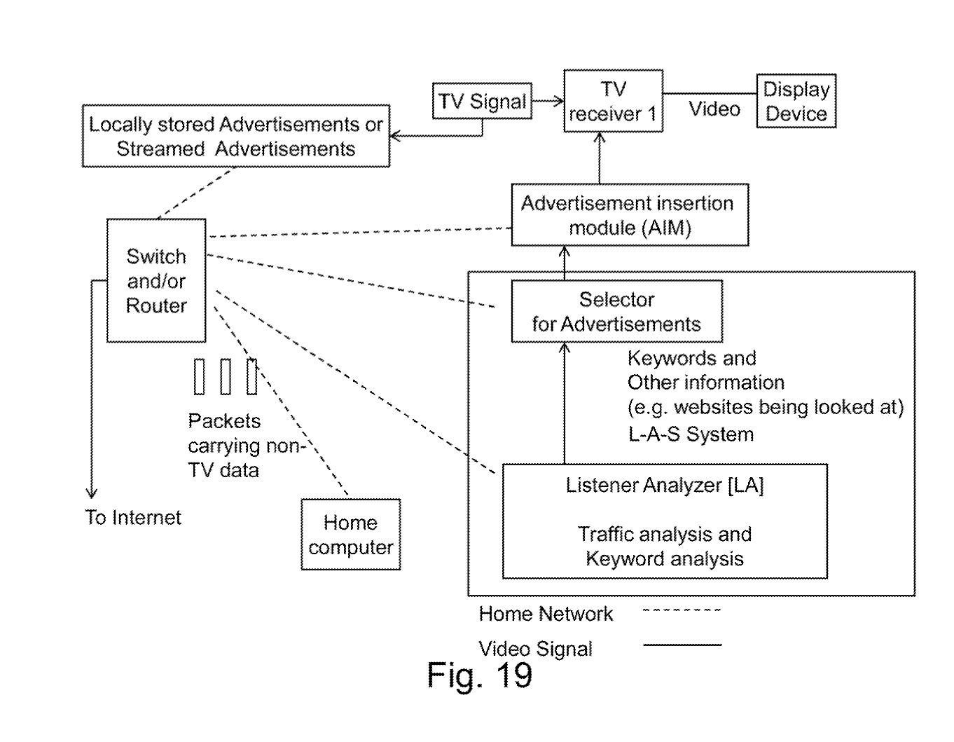

FIG. 19 is a schematic block diagram depicting a Listener-Analyzer-Selector (L-A-S) system. There are 2 separate functional elements to the system. The Listener Analyzer (L-A) and the Selector (S) together comprise the L-A-S system. The output of the L-A-S is sent to an ad insertion module (AIM) that executes the actual insertion of the advertisement into the device, for example, inserting a custom or targeted ad into the video stream going to the TV.

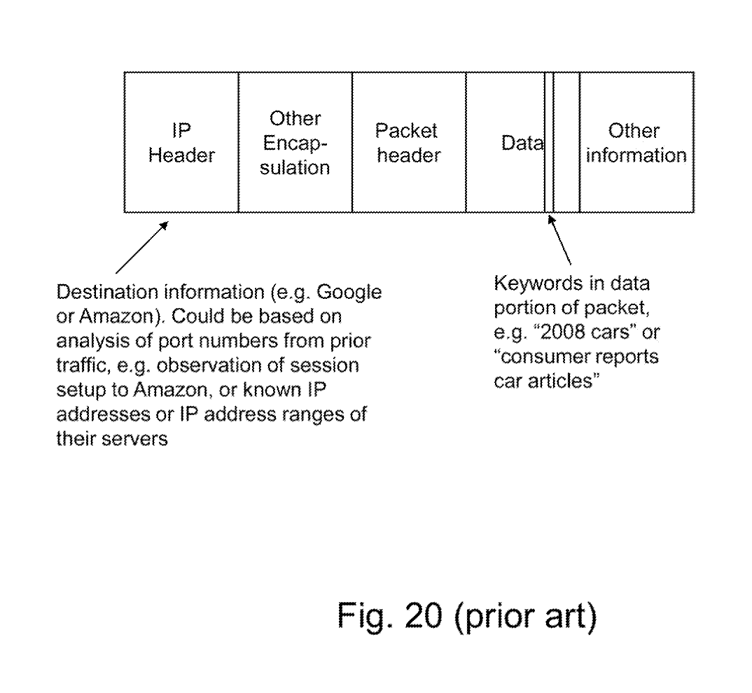

FIG. 20 is an exemplary packet (prior art). By looking at the packets passing through to the Internet and on the intranet, it is possible for the L-A to examine the content of the packets and look for keywords that may be used to determine whether the subscriber is searching for information, about, or is likely to have interest in an object. The packets may also be examined to determine the destination of the packet, and then the information about the destination may be correlated with the content of the packet to make an inference as to whether the customer is searching for a specific object. Further correlations between data from multiple packets, or from multiple sessions on the same, or across multiple computing devices may be used to more accurately determine user interests in a category or categories.

For example, if the user is looking to purchase a remote control, they may search for the words “remote control” on Google. Therefore, by correlating “Google” and “remote control” in the web traffic, an electronics retailer such as Best Buy can serve an advertisement informing the customer of a sale on remote controls. For example, if the customer searches for “Nikon. Camera” on Amazon, by correlating “Amazon” and “Nikon Camera”, a local camera retailer may serve an advertisement about sales on cameras, or a competing camera manufacturer such as Canon may serve an advertisement comparing their products with Nikon cameras.

Though the above description refers to deriving information relating to customer intent and interests from packets containing text such as web, email, documents, etc., the technique can be extended to discern customer interests and intent by examining other types of packets—e.g. patterns in gaming traffic to promote gaming accessories, games, and even game objects. Other types of traffic that can be analyzed to yield information about customer intent and interests include music, audio from VOW, photographs, video, interactive games, etc.

The output of the L-A is a detailed catalog of the user's traffic pattern organized by advertisement selection criteria scores for different time periods. One simple example of an advertisement selection criterion. is the relative score of keywords that are of interest to the advertiser. Other criteria may be more sophisticated. For example, the relative scores of keywords may be weighted to take into account meaning of sentences as well as the time history and frequency of the observed keywords.

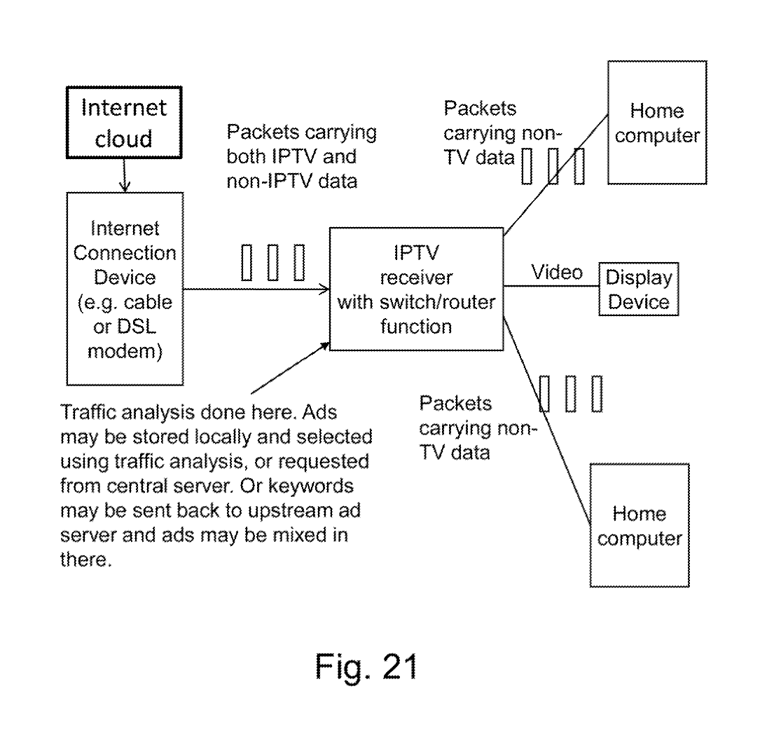

FIG. 21 is a schematic block diagram of an L-A system performing home network routing. Several methods may be used to look at the customer's intranet/Internet traffic, if the customer's computers are on a wireless network, the “over the air” traffic may be captured and decoded. For some networks, this may be very easy. In the case of more secure wireless networks, the customer may be asked to provide the password for the wireless network, which can then be used to decode the traffic and obtain data about whether the customer is searching for. Or, the L-A itself may provide the routing function for the home, in which case it has access to all the customer's internet traffic. Or, the L-A may be implemented as a software program that may be loaded onto the customer's computers, and the correlation and keyword search can be done there.

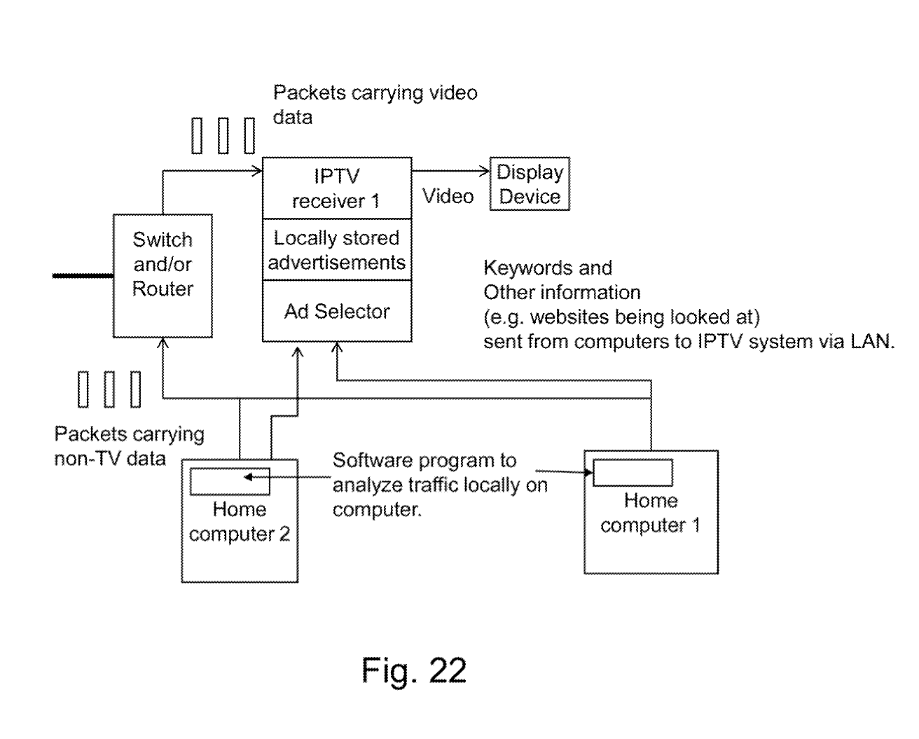

FIG. 22 is a schematic block diagram of a system designed to send information to a Selector system over the home's internal network. The job of the Selector is to select the best ad to be shown at any given time based on information collected by the L-A, on the available advertisements to be shown, and possibly other criteria specified by the providers of advertisement. Such criteria might include limits on the frequency of advertisements shown, rate of burn of budget for a particular advertiser, etc. This selection is then passed on to an Ad-Insertion Module (AIM) that handles the actual insertion of the advertisement into the video (or other media) stream.

The pre-stored list of advertisements may be refreshed from an external server to the Selector at periodic intervals, based on age or other criteria such as frequency of usage. The Selector communicates with the advertisement, insertion mechanism (AIM) to actually effect the interruption of the video stream and to slot in the selected Advertisement at the appropriate time. The AIM can be the TV, the STB, some place along the network, or potentially an outside service. One aspect of this system is to have the Selector be co-located with the STB, perhaps even integrated into the STB.

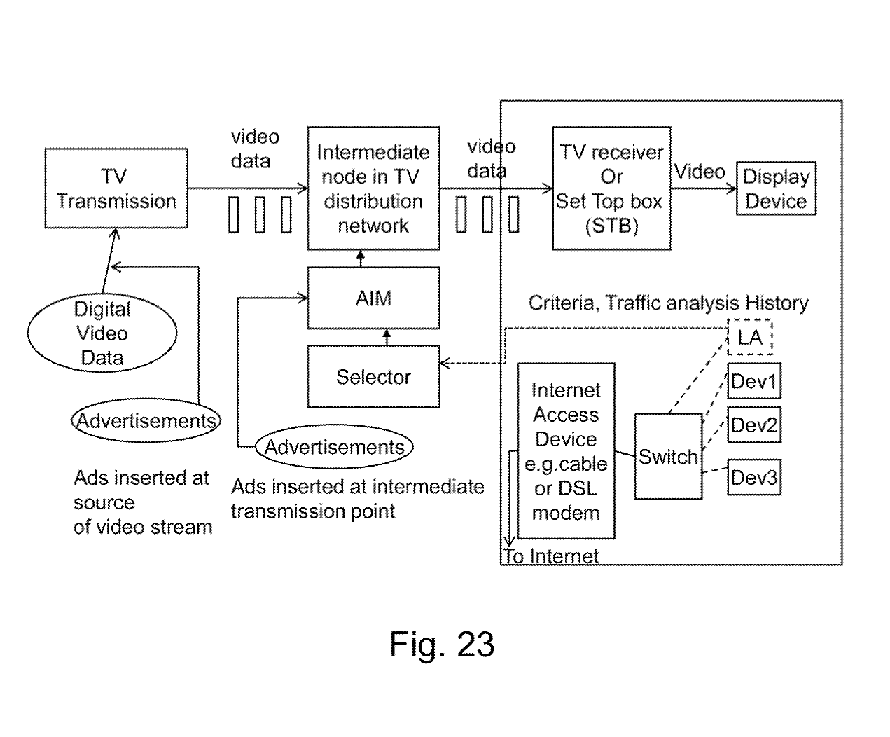

FIG. 23 is a schematic block diagram depicting a Selector located outside the home network. If the customer permits user specific information from the L-A (e.g., the criteria, and traffic analysis history) to be to be sent back outside the home, then an external server may use the information to select advertisements that are multiplexed into the customer's video stream. In this case the Selector is located outside the household premises somewhere along the TV network or at an Ad Server Company's network.

It should be noted that such a system does not need specially created advertisements to be useful; even if the traditional, broadly aimed advertisements currently in use are stored on the Selector, it is possible to use this method to do a better job of selecting which ones are shown to the customer, thereby increasing the effectiveness of the advertisements. So for example, more car advertisements than usual may be shown at a time when the customer is looking for a car; and more advertisements from electronics stores may be shown when the customer appears to be searching for electronics. Even this crude level of differentiation adds value.

In an alternative aspect, the L-A may examine the traffic, and then, without disclosing directly which objects the customer is looking for, the Selector system may request the server for a class of relevant advertisements. The Selector may then show one or more of these ads to the customer and discard the rest. For example, if it determines the user is looking for electronics, then it could request and receive advertisements from electronics stores without disclosing specifically the object of the customer search. Further obfuscation for the purpose of privacy may be achieved by requesting random irrelevant advertisements that are never used.

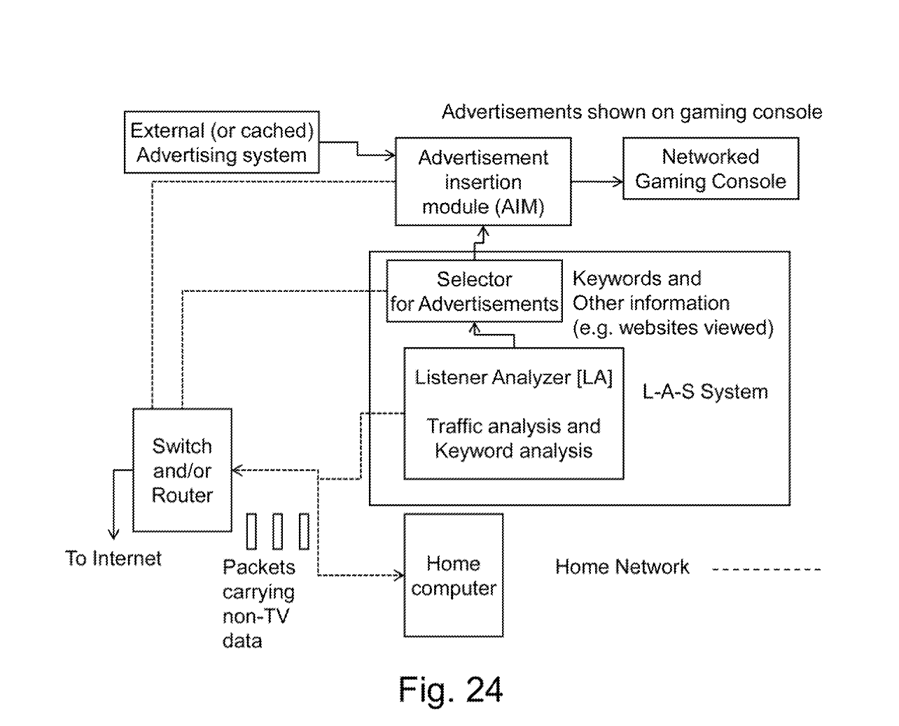

FIG. 24 is a schematic block diagram depicting an L-A-S system as applied to home network appliances, other than a television. Besides advertising delivered on TV, the L-A-S system is just as easily applicable to other platforms within the household, e.g., gaming systems, intelligent appliances, etc.

The targeted advertisement systems described above permits an aggregation of household behavior across all networked devices in the household, providing a level of analysis of user behavior/profiles that is not possible by the prior art. This includes the ability to more accurately understand user interest as a function of time. Privacy concerns may be mitigated by keeping all user information local. That is, the L-A-Selection system can use the gathered information to serve selected pre-cached advertisements, and the customer-specific information need not be transmitted outside the system except with the customer's permission. This is a substantial advantage over other systems that gather data outside the household. Further, the system is scalable. Locating the L-A system in a distributed fashion at the point of use substantially reduces or fully eliminates the need for investments in a large datacenter and/or large amounts of network bandwidth.

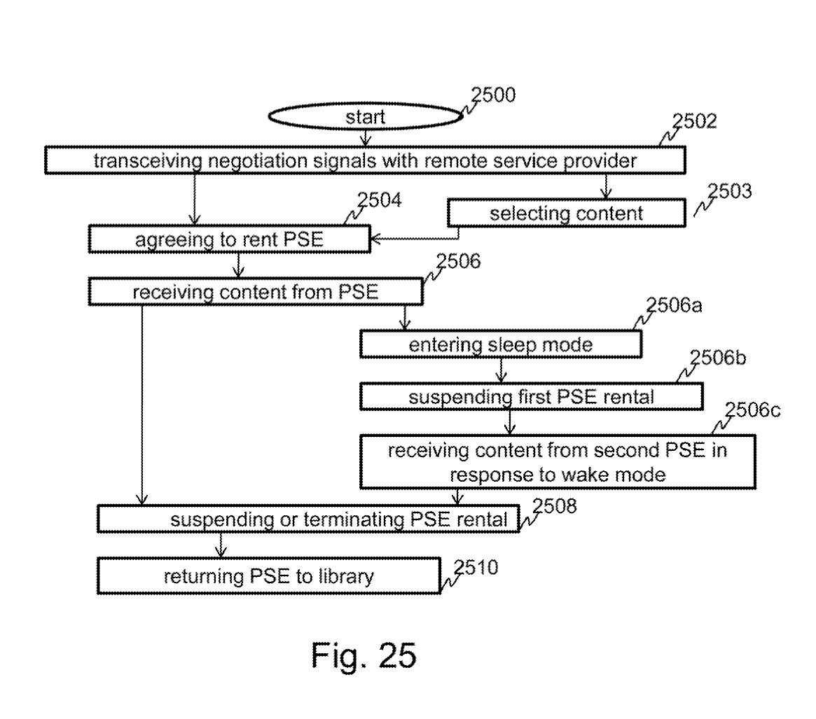

FIG. 25 is a flowchart illustrating a method for renting a peripheral storage entity from a remote site. Although the method is depicted as a sequence of numbered steps for clarity, the numbering does not necessarily dictate the order of the steps. It should be understood that in some aspects of the method some of these steps may be skipped, performed in parallel, or performed without the requirement of maintaining a strict order of sequence. Generally however, the process follows the ordered number sequence. The method starts at Step 2500.

Step 2502 transceives negotiation signals between a first client and a remote service provider, via a network link. As noted above, the first client may be a device, a user, or a device representing a user. In Step 2504 the first client uses the negotiation signals for agreeing to rent a peripheral storage entity from a remote site. The peripheral storage entity may be a DVD, high-definition (HD)-DVD, Blu-ray Disc™, CD, or gaming media cartridges. However, the method is not limited to any particular type of content or storage medium. In one aspect prior to agreeing to rent the peripheral storage entity, Step 2503 uses negotiation signals to select digital content. Then, agreeing to rent the peripheral storage entity includes agreeing to rent a peripheral storage entity with the selected content, located in a remote site library. Without taking physical possession of the peripheral storage entity, the first client receives digital content from the peripheral, storage entity via the network link in Step 2506. As noted above, at least some of these steps can be enabled as software instructions, stored in memory and executed by a processor.

Step 2508 either suspends or terminates the rental of the peripheral storage entity to the first client. In one aspect, terminating or suspending the PSE rental in Step 2508 includes automatically suspending or terminating the rental of the peripheral storage entity to the first client after n hours. Step 2510 returns the peripheral storage entity to a remote site library of available peripheral storage entities.

In one aspect, receiving digital content from the peripheral storage entity includes receiving content from a first peripheral storage entity assigned to the first client. The assigned peripheral storage entity may have a unique identification such as a physical marking on an exterior surface of the peripheral storage entity, a unique ID embedded in a disk burst cutting area, a unique ID embedded in the peripheral storage entity, or the peripheral storage entity may be unmarked, but residing in a marked storage slot. In another aspect, receiving content from the peripheral storage entity includes preventing a second client from receiving content from the (same unique) peripheral storage entity unless the first client rental is suspended or terminated. Content is received from the PSE via a network path linked to a remote second client, the service provider, or from both the second client, and the service provider.

In one aspect, receiving content in Step 2506 includes substeps. Step 2506a uses negotiation signals originating from the first client to enter a sleep mode. Step 2506b suspends the rental of a first peripheral storage entity to the first client. In Step 2506c the first client receives the content from a second peripheral storage entity, in response to sending a wake mode negotiation signal. In one aspect, Step 2506c receives content from a second peripheral storage entity if the first peripheral, storage entity is currently being rented to a second client.

Agreeing to rent the peripheral storage entity in Step 2504 may include agreeing to rent under one of the following terms: a single entity rental, the rental of n-entities, n-entity rental per calendar period, unlimited, unlimited per calendar period, rental with an option to purchase, pre-rental trial, virtual purchase, or rotated purchase. However, it should be noted that the method is not limited to any particular rental terms. In another aspect, Step 2504 agrees to rent a peripheral storage entity from a library distributed over a plurality of remote sites.

In one aspect, agreeing to rent the peripheral storage entity in Step 2504 includes accepting legal rights to the peripheral storage entity. Alternately stated, receiving content from the peripheral storage entity in. Step 2506 may include taking virtual possession of the peripheral storage entity. In Step 2504 the first client may agree to rent from the service provider or a network-connected remote second client. Alternately, the rental agreement may be made with both the service provider and second client.

In one aspect, Step 2504 agrees to rent a first PSE to the first client. In the event of the first client failing to receive content from a first peripheral storage entity, in Step 2506 the first client receives the content from a second peripheral storage entity located at a remote site.

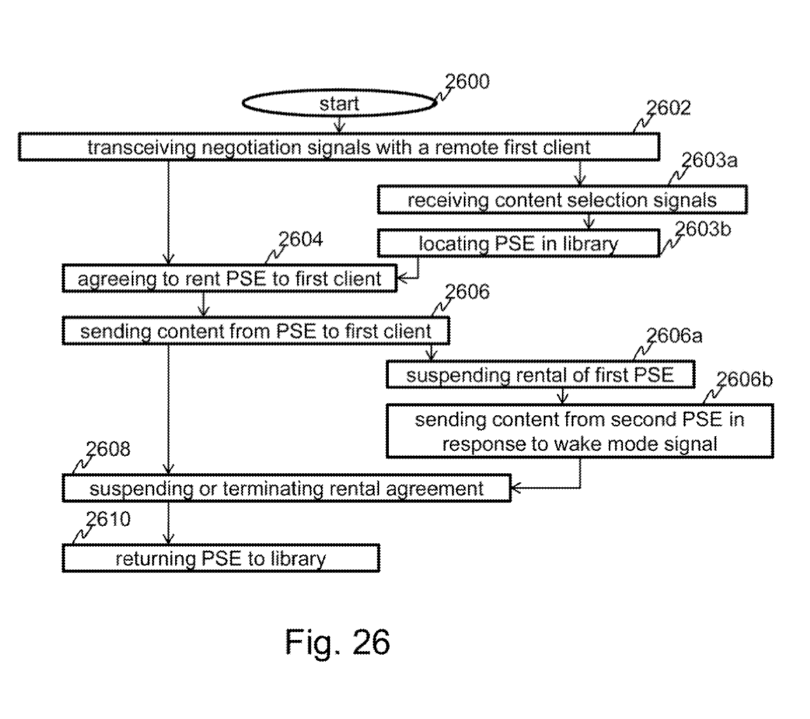

FIG. 26 is a flowchart illustrating a method for renting a peripheral storage entity to a remote client. The method begins at Step 2600. Step 2602 transceives negotiation signals between a remote first client and a service provider, via a network link. Using the negotiation signals, in Step 2604 the service provider agrees to rent a peripheral storage entity to the first client. Specific types of PSEs, rental terms, and PSE identifications are as mentioned above in the explanation of FIG. 25. Step 2606 sends digital content from the peripheral storage entity via the network link to the remote first client. The content is sent via a network path—from a remote second client, from the service provider, or from both the second client and the service provider. As noted above, at least some of these steps can be enabled as software instructions, stored in memory and executed by a processor. Step 2606 also may involve the manipulation and reading of a physical PSE and the use of a mechanical console.

Alternately considered, Step 2604 may agree to rent a peripheral storage entity from a library distributed over a plurality of remote sites. For example, the service provider may broker a rental agreement between the first client and a second client, where the second client is remote from both the service provider and first client. Then. Step 2606 sends content from a peripheral, storage entity located at the second client, to the first client. As another example, Step 2604 may create a relationship between the service provider and the first client, and a separate agreement between the service provider and the second client. Alternately, the rental agreement may be a three-party agreement between the service provider, the first client, and the second client.

Step 2608 suspends or terminates the rental of the peripheral storage entity to the remote first client. For example, Step 2608 may automatically suspend or terminate the rental of the peripheral storage entity to the first client after n hours, where n is a variable not limited to any particular value. Step 2610 returns the peripheral storage entity to a library of available peripheral storage entities. In one aspect, Step 2603a receives a digital content selection via negotiating signals from the first client, and Step 2603b locates the peripheral storage entity having the selected content in a library. Then, agreeing to rent the peripheral storage entity in. Step 2604 includes agreeing to rent the peripheral storage entity located in the library.

In one aspect, agreeing to rent the peripheral storage entity in Step 2604 includes extending the first client legal rights to the peripheral storage entity. Alternately considered, sending content from the peripheral storage entity in Step 2606 includes extending virtual possession of the peripheral storage entity to the first client.

In one aspect, sending digital content from the peripheral storage entity in Step 2606 includes sending content from a first peripheral storage entity assigned to the first client. In the event of a failure to send content from the first peripheral storage entity to the first client, Step 2606 may send content from a second peripheral storage entity. In another aspect, Step 2606 prevents a remote client from receiving content from the peripheral storage entity unless the first client rental has been suspended or terminated.

In one aspect, sending content in. Step 2606 includes substeps. In response to sleep mode negotiation signals from the first client. Step 2606a suspends the rental of a first peripheral storage entity to the first client. Step 2606b sends content to the first client from a second peripheral storage entity, in response to receiving a wake mode negotiation signal. In one aspect, Step 2606b sends content from the second PSE if the first peripheral storage entity is currently being rented to a second client.

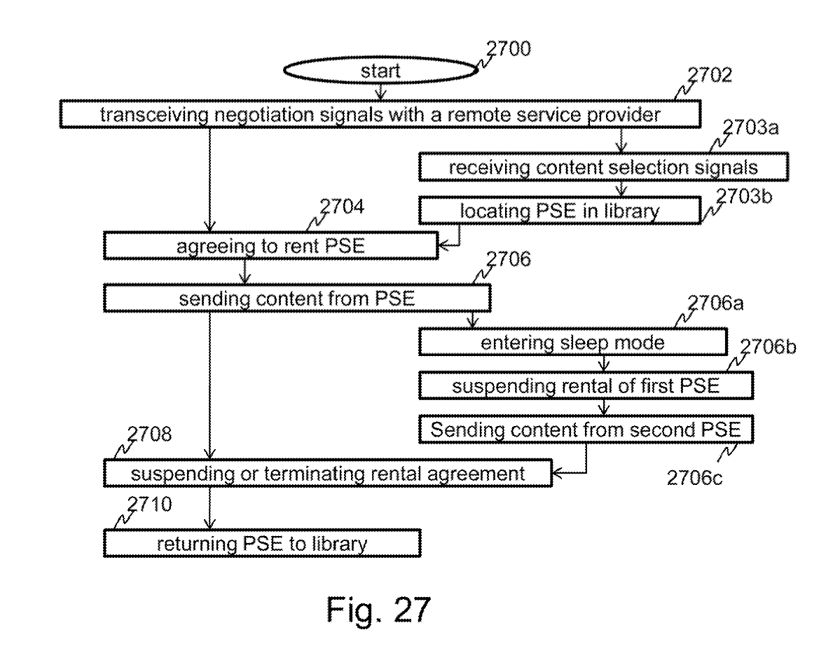

FIG. 27 is a flowchart illustrating a method for renting a peripheral storage entity to a remote client. The method begins at Step 2700. Step 2702 transceiver negotiation signals between a second client and a remote service provider, via a network link. Using the negotiation signals, Step 2704 agrees to rent the use of a peripheral storage entity. Examples of PSE types, rental terms, and PSE identification are as given above in the explanation of FIG. 25. The rental agreement of Step 2704 may be under terms of a relationship between the service provider, the first client, and the second client. Alternately, the agreement may be just with the service provider. In Step 2706 the second client sends digital content from the peripheral storage entity, destined to a remote first client, via the network. As noted above, at least some of these steps can be enabled as software instructions, stored in memory and executed by a processor. Step 2706 also involves the manipulation and reading of a physical PSE and the use of a mechanical console.

Typically, the performance of Step 2706 prevents a remote site from receiving content from the peripheral storage entity unless the rental agreement of Step 2704 is suspended or terminated. In Step 2706 content is sent via a network path, either directly to the first client (from the second client), or indirectly to the first client by way of the service provider. Step 2706 may be said to extend legal rights or virtual possession over the peripheral storage entity to the first client.

Step 2708 suspends or terminates the rental of the peripheral storage entity. For example, Step 2708 may be automatically performed after a predetermined amount of time from the enactment of Step 2704. In another aspect, Step 2708 is performed in the event of a failure to send content from the PSE. In a different aspect, Step 2706 sends content from a second peripheral storage entity, in the event of a failure to send content from a first peripheral storage entity. Step 2710 returns the peripheral storage entity to a library of available peripheral storage entities.

In one aspect, Step 2703a receives a digital content selection via negotiating signals, and Step 2703b locates the peripheral storage entity having the selected content in a library. Then, agreeing to rent the peripheral storage entity in Step 2704 includes agreeing to rent the peripheral storage entity with the selected content, located in the library.

In one aspect, sending digital content from the peripheral storage entity in Step 2706 includes sending content from a first peripheral, storage entity assigned to the first client. In one variation Step 2706a enters a sleep mode in response to negotiation signals, and Step 2706b suspends the rental of a first peripheral storage entity. Then Step 2706c sends content from a second peripheral storage entity, in response to receiving a wake mode negotiation signal in one aspect, Step 2706c sends content from the second PSE if the first peripheral storage entity is currently being used under terms of a different rental agreement.

A method for accelerating and dispersing video transcoding is also disclosed herein, as a means of supporting data transfers from a remote second client to a remote first client. While explicitly directed to video transcoding, it should be understood that the method has a more general application to all calculations. That is, a mechanism is disclosed that allows for the acceleration, of complex but repetitive mathematical computations, for example, real-time video transcoding, and allows the results to be evaluated at points geographically dispersed by many miles from the source of the calculations by remote (as defined above) devices.

Conventionally, the acceleration of computations can be accomplished by the use of more efficient or faster hardware. It can also be accomplished by using more efficient algorithms. Alternately, the dispersion of calculations via distributed computing is a fairly well established art. Further, video streaming is usually accomplished by real-time transcoding to the desired format, or by pre-processing to create an entire file fully transcoded. Current distributed state of the art for transcoding of video requires higher levels of bandwidth usage than the acceleration means described herein.

To support the system and methods described above in the explanations of FIGS. 1-27, an improved approach would be desirable for on-the-fly transcoding of audiovisual streams from DVDs or other sources to various bit rates depending on the available bandwidths for the stream. At a minimum, some issues to consider are:
a) The source material must be played (by a physical console) each time prior to transcoding in order to generate the stream that needs to be transcoded.
b) minimize costs in an environment sourcing a plurality of concurrent data streams, a reduction in the transcoding computational load at the originating server is desirable.
c) reduction of the bandwidth at the originating server. This is important because the bandwidth availability may be limited, and if more concurrent streams can be “squeezed” out of the originating data center, there is greater capacity for a given bandwidth speed. Furthermore, bandwidth requirements can be ramped up/down on-demand without pre-purchasing very fat pipes upfront. Also, pipes can be provisioned in real-time, closer to the arbitrary user, rather than needing it at the source where the physical discs are located.

FIG. 28 is a schematic block diagram depicting conventional on-the-fly video transcoding (prior art). It should be understood that video is a general term for a stream that contains video, audio, control information, and other information including, but not limited to a second audio program or subtitles. Here the source material, say from a camera or DVD 2800, is played or streamed to a transcoder 2802. Let the input format be Format A (e.g., MPEG2, MPEG4, WMV, etc.) encoded at bitrate C.

This input data is processed by the transcoder 2802 and produces an output stream in Format B with Bitrate D. The transcoder may or may not be real-time, but in this example real-time transcoding applications are assumed.

FIG. 29 is a schematic block diagram depicting a first aspect of a transcoding accelerator. The following steps are followed:

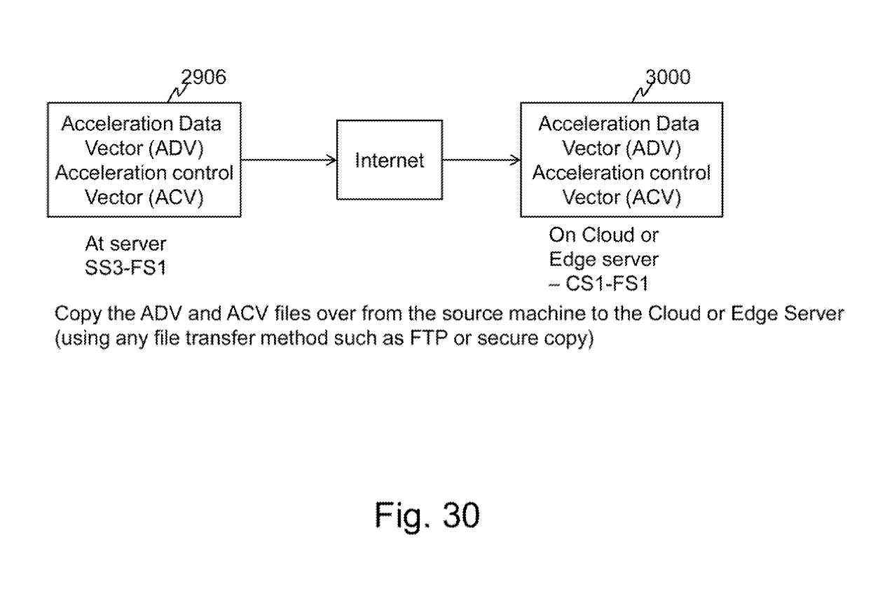

1. Computation of the acceleration data vector.
a. As shown, source material from server SS1 (2900) is played/streamed. Let this be stream S1 with source Format A and Bitrate C, Transcode S1 to the required format and hit-rate—say Format B and Bitrate D, on server SS2 (2902). This process may or may not be performed in real-time. Let this transcoded stream be stream S2. Transform A 2904 is then applied to stream S2. Transform A can be implemented either in hardware or in software.
b. Application of Transform A to stream S2, on server SS3 (2904), results in the creation of the acceleration data vector—the ADV which may be saved as a file. It also creates the Acceleration Control Vector which may be saved as a file. This is the ACV file. These files are saved on the file server attached logically to SS3, i.e. SS3-FS1 (2906).
c. FIG. 30 is a schematic block diagram depicting the movement of the ADV and ACV files to the file server attached logically to the cloud server CS1-FS1 3000. The filed are moved by any file transfer mechanism, e.g., file transfer protocol (FTP) or secure Copy.

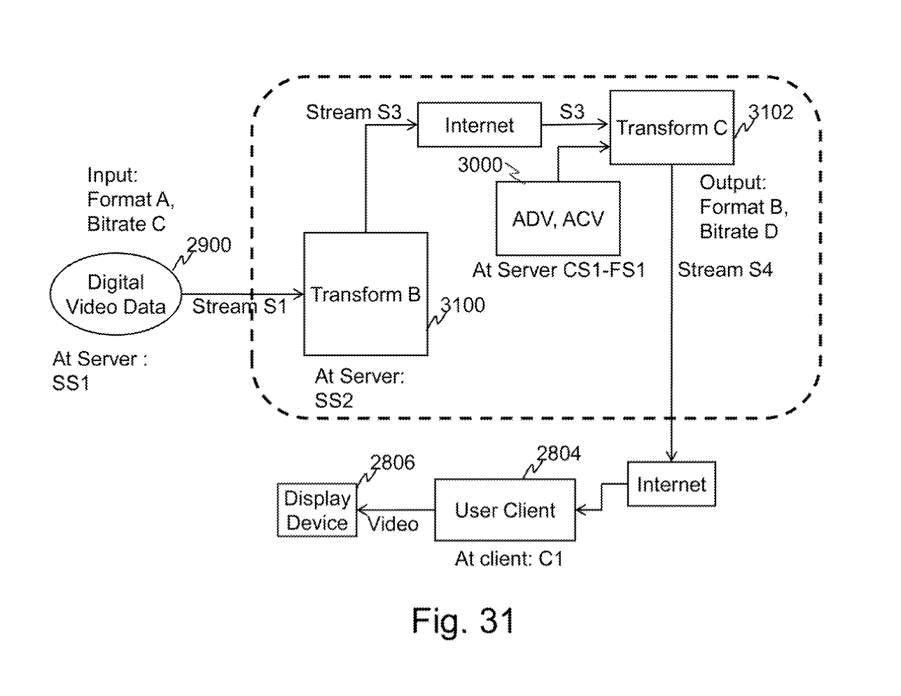

2. FIG. 31 is a schematic block diagram depicting a second aspect of accelerated transcoding. The box in phantom lines is the accelerator transcoder, and performs the same function as the transcoder of FIG. 28, with several advantages.
a. Stream the source material from the source server SS1 (2900). This is stream S1. Apply Transform B, to this stream S1 to create a stream S3 on server SS2 (3100). Stream this data over the Internet (or local, network) to the cloud server CS1 (3000).
b. At this cloud server CS1 (3000), apply transform C to the stream S3, using the Acceleration Data Vector (ADV) and the Acceleration. Control Vector (ACV) from file server CS1-FS1 to produce stream S4 with Format B, and Bitrate D.
c. This stream S4 is sent to the client at machine C1 (3102) where it is decompressed and displayed locally to the user on the display device 2806. Note that Stream S4 in FIG. 31 is identical to Stream S2 in FIG. 28, i.e. the components within the phantom lines represent the “accelerated” transcoder.

### Transform A

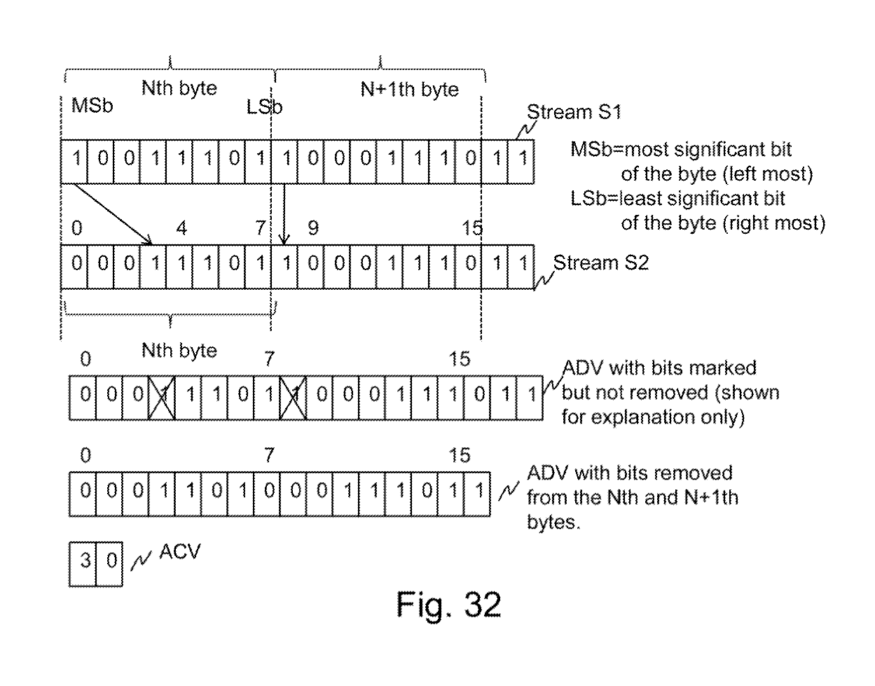

FIG. 32 is a diagram illustrating an exemplary process to support Transform A. Note: for clarity a simple process is used, but the acceleration mechanism is not limited to just this exemplary process. First, breakup stream. S1 and S2 into matched segments of, say, 100 bytes (or 800 bits). For ease of illustration, this description assumes that the lengths of stream S1=length of stream S2, but this is not a requirement for this process. In general, the length of stream S1 is different, and usually greater than the length of stream S2.

For each segment:
For each byte N:
1. Take the most significant bit of S1. Let its value be V (in this example “1”).
2. For the corresponding byte, i.e. the Nth byte, in S2, find the first hit, scanning from most significant value to least significant value, that has the same value, V, as the hit found in step B above. Let the position of this bit be M. (in this example “3” if we start counting the first bit as 0).
3. Remove bit M from byte N of stream S2.
4. Append the value M to the file ACV (the acceleration control vector).
5. Upon reaching the end of the segment, write the processed segment of stream S2 to the file ADV.

### Transform B

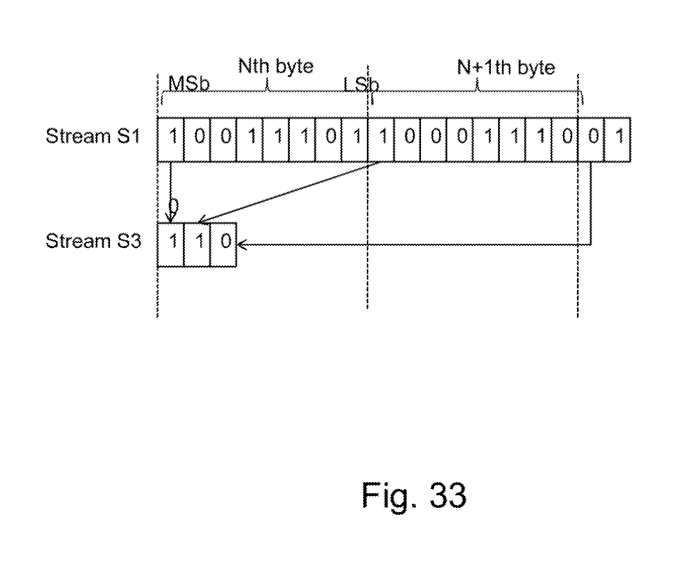

FIG. 33 is a diagram illustrating an exemplary process to support Transform B. Assume stream S1 and S2 are broken into matched segments of 100 bytes in the earlier step, i.e. Transform A.

For each segment:
For each byte N:
1. Take the most significant bit of S1. Let its value be V (in this example, the value is “1”).
2. Transmit value V to the server CS1 as stream S3.

Upon reaching the end of the segment, proceed to the next segment.

### Transform C

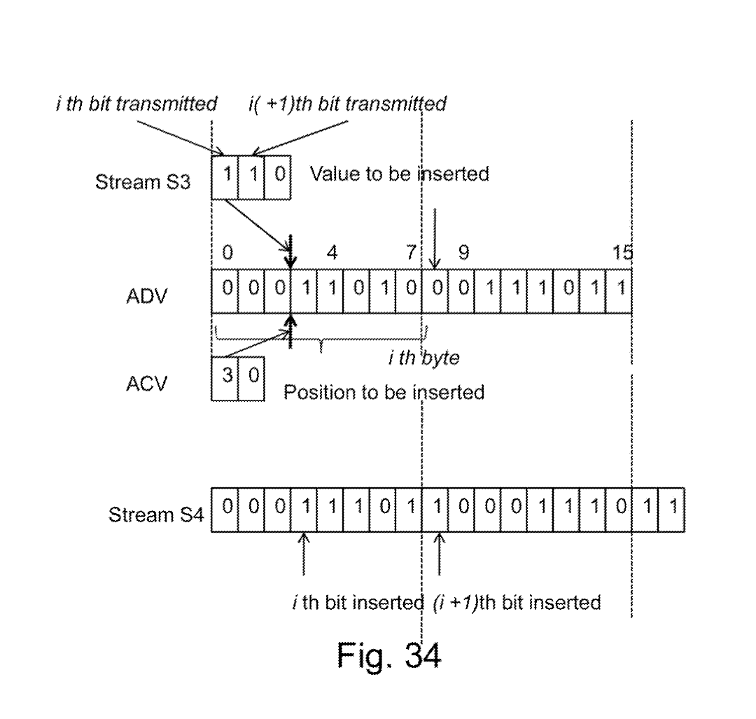

FIG. 34 is a diagram illustrating an exemplary process to support Transform C. Assume stream S1 and S2 are broken into matched segments of 100 bytes in the earlier step, i.e. Transform A.

For each segment K:
For the ith bit received—let this value be V (in the example shown, the value is of V is “1”):
1. Move forward to the start of ith byte of segment K of the ADV.
2. Read the value of the ith value of segment K of the ACV—let this value be “A”. (in the example “A”=“3”).
3. Insert the value V before the Ath bit in the ith byte of segment K of the ADV.

Upon reaching the end of the segment, append the segment to stream S4. Proceed to the next segment.

Advantageously, the above-described method allows for the acceleration of video processing algorithms so as to minimize the hardware costs associating with transcoding particular types of video streams—specifically, those where either the entire video or large portions of it are played repeatedly. This method also allows for the acceleration to take place at disparate locations allowing for reduction in bandwidth at the source, and increased stability of transmissions over long distances.

Systems and methods of remote PSE rental have been provided, along with associated advertisement options. Specific examples of devices and process steps have been given to illustrate the invention. However, the invention, is not limited to merely these examples. Other variations and embodiments of the invention will occur to those skilled in the art.

We claim:

1-20. (canceled)

21. Using a non-transitory computer readable medium, a method for deriving a privacy-protected Internet client interest profile, the method comprising:
monitoring messages transceived between a home network and a broadband modem connected to an Internet network;
a listener-analyzer (L-A) device, residing in the home network, analyzing the content of the monitored messages; and,
the L-A device deriving a client interest profile from the analyzed content.

22. The method of claim 21 further comprising:
matching the client interest profile to user interest-matched content; and,
inserting the user interest-matched content into downstream messages received by the home network.

23. The method of claim 22 wherein inserting the user interest-matched content into downstream messages received by the home network includes inserting the user interest-matched advertising into audio/video programs.

24. The method of claim 23 wherein inserting the user interest-matched advertising into audio/video programs includes:
receiving audio/visual programs, with advertising, via a broadcast network; and,
replacing the received adverting with the user interest-matched advertising.

25. The method of claim 22 wherein matching the client interest profile to user interest-matched content includes a selector device, residing in the home network, selecting user interest-matched content that matches the client interest profile.

26. The method of claim 25 wherein inserting the user interest-matched content into downstream messages received by the home network includes an advertisement insertion module (AIM), residing in the home network, inserting the user interest-matched content.

27. The method of claim 25 wherein the L-A device deriving the client interest profile from the analyzed content includes establishing the L-A device as part of a distributed client interest database, where each home network protects client privacy by maintaining exclusive control over associated client interest profiles and associated user interest-matched content.

28. The method of claim 25 wherein the selector device selecting user interest-matched content that matches the client interest profile includes the selector device matching the client interest profile to user interest-matched content stored locally in the home network.

29. The method of claim 28 further comprising:
refreshing the locally stored user interest-matched content from a source external to the home network.

30. A system for deriving a privacy-protected Internet client interest profile, the system comprising:
a home network including at least one computing device enabled with hardware;
a broadband modem, enabled with hardware, having a wide area network (WAN) interface connected to an Internet network and a local area network (LAN) interface connected to the home network; and,
a listener-analyzer (L-A) device residing in the home network and configured to monitor messages transceived between the broadband modem and the home network, the L-A device analyzing the content of the monitored messages and deriving a client interest profile from the analyzed content.

31. The system of claim 30 further comprising:
a selector device having an interface connected to the L-A device and configured to associate the client interest profile to user interest-matched content; and,
an ad insertion module (AIM) having an interface connected to the selector device and configured to insert the user interest-matched content into downstream messages received by the home network.

32. The system of claim 31 wherein the AIM inserts user interest-matched advertising into audio/video programs.

33. The system of claim 32 wherein the AIM replaces broadcast advertising received in a broadcast network audio/visual program, with the user interest-matched advertising.

34. The system of claim 31 wherein the selector device resides in the home network.

35. The system of claim 34 wherein the AIM resides in the home network.

36. The system of claim 34 further comprising:
a plurality of home networks; and,
a plurality of L-A device and selector device sets, each set residing in a corresponding home network, the plurality of sets forming a distributed client interest database, where each set protects client privacy by maintaining exclusive control over associated client interest profiles and associated user interest-matched content.

37. The system of claim 34 further comprising:
a local memory residing in the home network; and,
wherein the selector device associates the client interest profile to user interest-matched content stored in the home network local memory.

38. The system of claim 35 further comprising:
a computer device comprising:
a processor;
a non-transitory memory;
an application comprising a sequence of software instructions stored in the non-transitory memory and executable by the processor; and,
wherein the broadband modem. L-A device, selector device, and AIM are integrated into the computer device.

39. The system of claim 38 wherein the computer device comprises a plurality of broadband modems to communicate with a corresponding plurality of WANs.

40. Using a non-transitory computer readable medium, a method for privacy-protected client-interested advertising, the method comprising:
monitoring messages transceived between a home network, and a broadband modem connected to an Internet network;
a listener-analyzer (L-A) device, residing in the home network, analyzing the content of the monitored messages;
the L-A device deriving a client interest profile from the analyzed content;
a selector device, residing in the home network, matching the client interest profile to user interest-matched advertising;
an ad insertion module (AIM), residing in the home network, inserting the user interest-matched advertising into downstream messages received by the home network; and,
wherein the steps of monitoring the messages, analyzing the message content, deriving the client interest profile, and inserting the user interest-matched advertising are performed without transmitting client information upstream from the home network to the Internet network.
